(19) United States
(12) Patent Application Publication
(10) Pub. No.: US 2019/0228490 A1
(43) Pub. Date: Jul. 25, 2019

(54) GLOBAL DIGITAL FRAMEWORK INTEGRATED TO DEVELOP ECONOMICALLY COMPETITIVE MUNICIPALITIES

(71) Applicants: Ricardo Alejandro PRIETO MARQUEZ, EL PASO, TX (US); SUSTAINABLE MUNICIPALITY LLC, New York, NY (US); EXXISTECH LIMITED, Linlithgow (GB)

(72) Inventor: Ricardo Alejandro PRIETO MARQUEZ, EL PASO, TX (US)

(21) Appl. No.: 16/337,924

(22) PCT Filed: Oct. 6, 2016
(86) PCT No.: PCT/IB2016/002015

§ 371 Date: Mar. 29, 2019

(51) Int. Cl. G06Q 50/26; G06Q 10/06; G09B 19/00

(52) U.S. Cl. CPC G06Q 50/26; G06Q 30/0261; G09B 19/00; G06Q 10/0637

(57) ABSTRACT

A global digital framework integrated by methods, systems, processes, and new thinking technologies focused on the development of secure, sustainable, collaborative, intelligent, resilient, and economically competitive municipalities. The frameworks intends to provide high quality knowledge, multimedia information, and municipal/city strategies in sectors such as education, security, energy, water, health, information technologies (IT), transportation, construction, food, environment, waste, and fmance; through the use of virtual reality technologies, algorithms, personal computer technology, big-data technologies, smart-phone technology, GPS technology, artificial intelligence systems, digital videos, behavioral change technologies, augmented reality systems, and digital advisory systems among other technologies.

### CROSS REFERENCE TO RELATED APPLICATIONS (IF ANY). (RELATED APPLICATIONS MAY BE LISTED ON AN APPLICATION DATA SHEET, EITHER INSTEAD OF OR TOGETHER WITH BEING LISTED IN THE SPECIFICATION.)

Not Applicable

### STATEMENT OF FEDERALLY SPONSORED RESEARCH OR DEVELOPMENT (IF ANY)

Not Applicable

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not Applicable

### REFERENCE TO A “SEQUENCE LISTING,” A TABLE, OR A COMPUTER PROGRAM-LISTING APPENDIX SUBMITTED ON A COMPACT DISC AND AN INCORPORATION BY REFERENCE OF THE MATERIAL ON THE COMPACT DISC. THE TOTAL NUMBER OF COMPACT DISC INCLUDING DUPLICATES AND THE FILES ON EACH COMPACT DISC SHALL BE SPECIFIED

Not Applicable

### BACKGROUND OF THE INVENTION

### Background

Albert Einstein mentioned that “we can't solve problems by using the same kind of thinking we used when we created them” (Harris, K, 2015)¹, and perhaps this is the biggest problem that the world is facing nowadays. Current megatrends such as demographic growth, urbanization, climate change, natural disasters, epidemics, artificial intelligence, global economic interdependence, decentralized terrorism, resources depletion, environmental degradation, cybersecurity risks, economic volatility, and exponential technological innovation are impacting cities as never seen before in human history. These trends are creating more stress in municipal systems, complexity in cities, vulnerability in global supply chains, economic uncertainty, systemic risks, global economic volatility, and new challenges in the area of municipal investments and decision-making processes in government. Therefore, it is highly likely that municipalities will be impacted drastically in the areas of economic development, food/energy/water supply chains, immigration patterns, culture, regional security, and in the performance of elected politicians by these potential trends. Consequently, this context is creating a need for our civilization to have a different kind of thinking to face these complex challenges during the 21^{st} century. Harris, K. (2016). Stanford university.https://rescomp.stanford.edu/˜cheshire/EinsteinQuotes.html Retrieved on 5 Mar. 2016.

Therefore, government leaders, business leaders, scientists, and citizens may need to develop a different kind of thinking during the 21^{st} century if they want to remain competitive and thrive in the global arena. Governments need leaders with systems thinking mentality, making leaders more aware of short and long-term challenges, and with a global sustainable vision to develop secure, resilient, collaborative, intelligent, and economically competitive governmental systems. Democracies may not always select the best leaders since democratic societies sometimes select the best speakers. However, science and technology can provide better tools for elected leaders to improve their decision-making and investments. The present methods, systems, processes, and technologies have the objective of improving the kind of thinking of leaders of more than 100,000 municipalities around the world by making leaders more aware of current megatrends, key sectors, pragmatic innovative ideas, successful cultural systems, technology risks, community collaboration systems, and strategies to have a successful mandate period. The objective of the present invention is to have a global, interactive, pragmatic, efficient, cost-competitive, and multilingual digital framework through the integration and combination of virtual reality tools, videos, behavioral technologies, educational technologies, smart-phone technology, and artificial intelligence (among other technologies) supporting local governments with better decision support tools to develop secure, sustainable, collaborative, resilient, and economically competitive municipalities. To better understand the purpose of the present methods, processes, systems, and technologies, the following paragraphs describe how global megatrends may impact municipalities during the coming decades.

### Megatrends

Municipalities and local governments will face important challenges during the following decades. Some of the global trends are so strong that may behave as megatrends impacting significantly several sectors and countries around the world. These megatrends may have important impacts on municipalities and cities such as the creation of government deficits, inefficient democratic systems, poverty, refugee crisis, national security, regional chaos, and political unrest. These megatrends may also impact regional economies creating conditions for regional conflicts and higher competition for regional resources, and consequently, exacerbating nationalistic sentiments among nations. Thus, global leaders must be aware of some of the most important megatrends affecting municipalities worldwide, and these trends can be summarized in 12 areas. For the purpose of developing the present invention these megatrends are defined as: (M1) demographic growth, (M2) urbanization, (M3) climate change, (M4) natural disasters (e.g. earthquakes, tsunamis, volcanic eruptions, meteorites, etc.), (M5) pandemics/epidemics, (M6) high reliance on ICT/artificial intelligence, (M7) global economic interdependence, (M8) decentralized terrorism, (M9) resource depletion (e.g. environmental degradation), (M10) cybersecurity, (M11) economic volatility, and (M12) exponential global innovation (e.g. emerging technologies). These 12 megatrends are creating the need to develop more intelligent, secure, sustainable, resilient, collaborative, and economically competitive municipalities. However, it is important to be aware that megatrends will have a different impact level depending on the municipality, state, and country. Some of the potential impacts on municipalities are described in the following paragraphs.

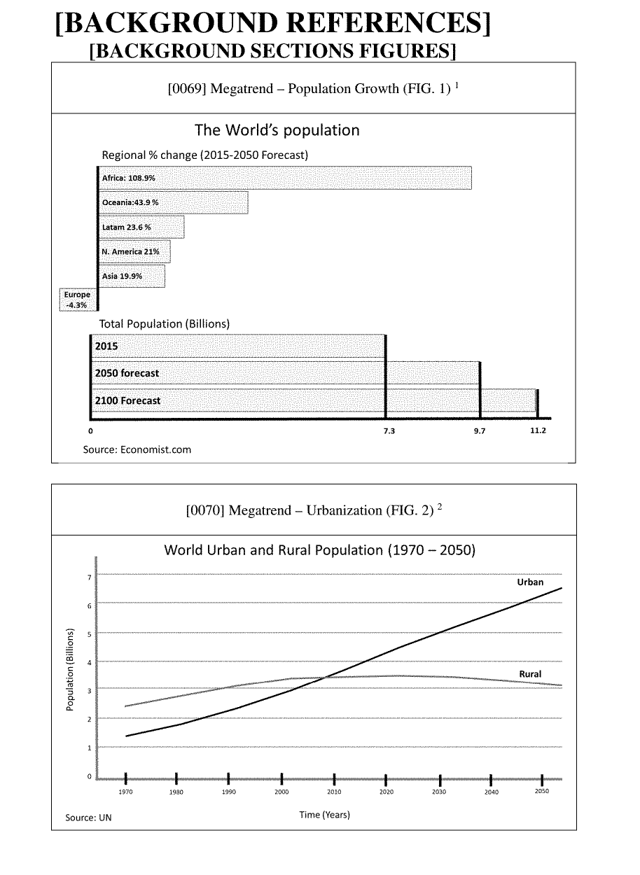

M1—Population Growth (FIG. 1): ² Although population growth rate has decreased in some parts of the world, it is still expected that more population will inhabit the planet by 2050 as shown in FIG.1. and sometimes could be difficult to realize the speed of change that our planet is experiencing. Even though some countries experience negative population growth, most emerging and developing economies may experience accelerated growth. According to the UN, the world's two most populated countries alone, China and India, together constitute about 37% of the world's population. It is expected that India will be the most populated country in the world during the 21^{st} Century. For instance, the Population Reference Bureau highlights that “the global population has grown from 1 billion in 1800 to 7 billion in 2012. Global population is expected to keep growing, where estimates have put the total population at 8.4 billion by mid-2030, and 9.6 billion by mid-2050 ” ³. The Economist magazine highlights UN statistics predicting that the world could reach 11.2 billion inhabitants by 2100 ⁴. This could mean higher densities in cities, more demographic changes, and more consumption creating more difficult conditions for municipalities to provide basic services such as water, health, energy, transportation, waste management, education, and security. Therefore, it is highly likely that more people in municipal systems will create more complexity for government leaders and investors. ² Economist. (2015). Retrieved from: http://www.economist.com/blogs/graphicdetail/2015/08/daily-chart-growth-areas³ Population Reference Bureau. (2013). www.pbr.org. Population Reference Bureau. Retrieved 5 Dec. 2014.⁴ Economist. (2015). Retrieved from: http://www.economist.com/blogs/graphicdetail/2015/08/daily-chart-growth-areas

M2—Urbanization (FIG. 2)⁵: The world has experienced a level of urbanization never seen before in human history before. The United Nations (UN) projected that half of the world's population would live in urban areas at the end of 2008. According to the UN, by 2050 it is predicted that 64.1% of the developing countries and 85.9% of the developed world will be urbanized.⁶ This accelerated and unplanned urbanization, particularly in the developing world, could create problems related to floods, land use, migration, climate change issues, poverty, sanitation problems, higher unemployment, terrorism, and more crime. For instance, forced or unplanned migration often results in rapid slums growth. Additionally, some municipalities could experience an accelerated growth of the good and services required by their inhabitants. Finally, higher population densities may create more complexity at the time of modifying existing transportation systems, land use, security systems, border control, energy, water, and health systems. ⁵ UN. (2014). Concise Report of The World Population Situation in 2014. Department of Economic and Social A airs Population Division. ST/ESA/SER.A/354⁶ UN. (2014). World Urbanization Prospects.

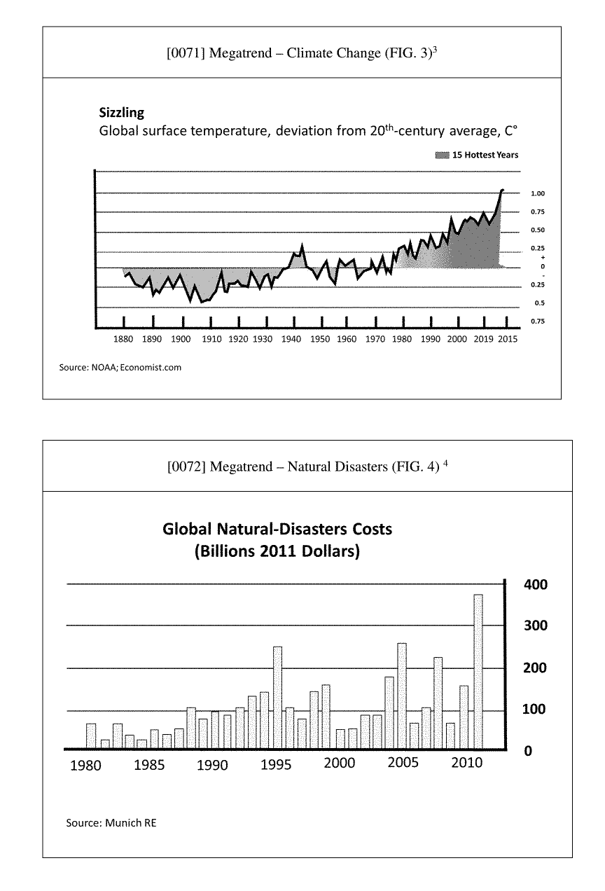

M3—Climate Change (FIG. 3)⁷: Climate change may be one of the most important challenges impacting and disrupting municipalities. Floods, heat waves, droughts, hurricanes, and snow torments; combined with new real estate developments, new land use, and less physical space; could create disruptions and extreme economic losses when disasters related to climate change occur. Likewise, these disasters may create unexpected deficits in the budgets of municipalities (see also FIG. 4). Due to higher population densities and to the potential effects of climate change, cities and municipalities may become more vulnerable to natural disasters such as floods, cyclones, and droughts creating more stress in social systems, higher economic volatility in regional systems, and more government deficits. ⁷ Economist. (2016). Retrieved from: http://www.economist.com/blogs/graphicdetail/2016/01/climate-change

M4—Natural Disasters (e.g. Volcanic eruptions, meteorites, earthquakes, etc.) (FIG. 4)⁸:

Other natural disasters non-related to climate change such as earthquakes, tsunamis, meteorites, changes in the earth's magnetic field, and solar explosions might be more difficult to predict in order to be prepared for their impact. Although some of these events are more likely to happen only in specific places (because of geography or local circumstances), the challenge is that some municipalities in the world have been developed without taking into consideration the risks of these events or infrastructure has been developed without applying the best international standards to face such events. For instance, the volcanic eruptions in Iceland (2010) and Chile (2011) had important effects on the air traffic control impacting some regions significantly. Although these events were “moderate” events, other future events could have a devastating ⁸ Economist. (2014). Retrieved from: http://www.economist.com/node/18488306?zid=313&ah=fe2aac0b11adef572d67aed9273b6e55 impact on regional economies creating a global economic crisis, interrupting global supply chains, and creating a higher uncertainty in the global economy. These events could create less economic growth, less employment, more migration, and more stress in the global system. Another example is the Fukushima disaster in Japan (2011), which had important short-term effects in the regional economies and had devastating effects in the local industry stopping the supply chains of auto-parts needed to manufacture cars in other parts of the world.

Other examples are the Nepal earthquake and the Hurricanes Rita/Katrina/Sandy in the USA. These are clear examples of how natural disasters could impact the economy of municipalities and of how these events can create a severe impact on the budgets of governments. Consequently, these events create the necessity of developing more interdependent systems combined with decentralized systems to ensure the short-term supply of energy, water, and food supplies to decrease the negative impact of natural disasters, wars, or other unexpected events. For instance, communities that consume less water on a per-capita basis (because of water conservation technologies) may be more resilient in case of natural disasters since these communities would need fewer water resources to survive in case of any water shortages. Finally, although not all goods can be produced locally, it would be convenient for municipalities to have efficient production systems at a local level to increase the resilience and security of municipalities.

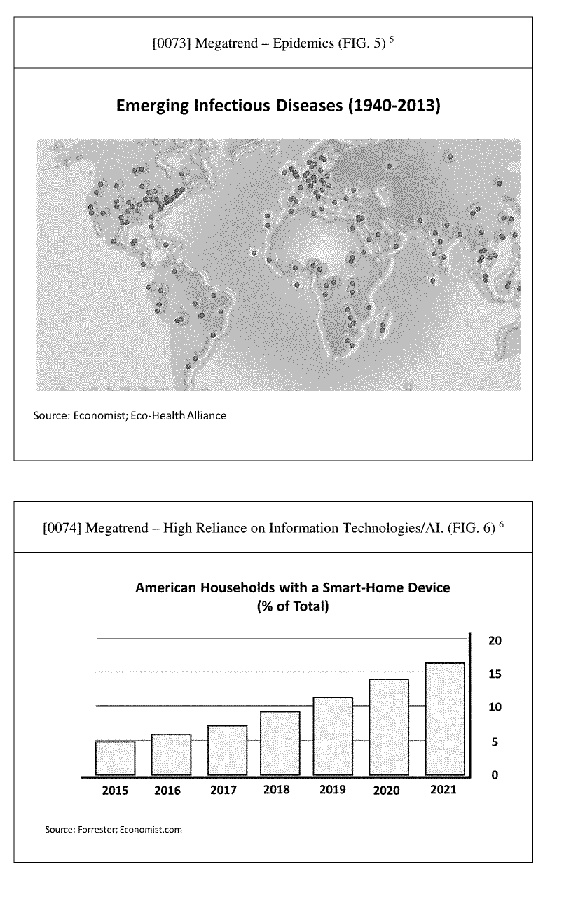

M5—Epidemics, Engineered Pandemics, and Antibiotic Resistance (FIG. 5) ⁹: A highly interconnected world, where any person can be physically at any part of the world within 12 hours, creates a high level of interconnectivity where an epidemic can become a pandemic easily in a matter of days. Also, the antibiotic resistance developed lately in our society may create more vulnerability scenarios in the areas of pandemics and vaccines resistance. Additionally, advances in the biotech and genomic science have created the capability for governments to develop engineered pandemics without knowing the consequences that such bioweapons could bring to the world (such as existential risks for humanity). These scenarios are important aspects to consider for municipalities at the time of developing their plans in the area of public health and economy. For instance, Ebola, SARS, and N1H1 had considerable negative social effects in the economy and created an unexpected economic crisis in some of the municipalities impacted by the epidemics. ⁹ Economist. (2016). Retrieved from: http://www.economist.com/news/leaders/21695036-crises-infections-disease-are-becoming-more-common-world-should-be-better-prepared

M6—High Reliance on Information Technologies/AI (FIG. 6)¹⁰: Internet and Information Technologies (IT) have been one of the most disruptive technologies in the last 30 years. They have transformed the way societies communicate, develop businesses, create new knowledge, and manage organizations. Information technologies have improved the economy and have been a catalyzer of progress. On the other hand, information technologies have made societies more dependent on technological tools putting at risk personal information, security, economy, intellectual property, and basic infrastructure. Among the most important trends related to this issue are: A higher reliance of information systems, that without proper information security standards and good governance frameworks, can create important challenges for the resilience of municipalities; a higher reliance of information technologies could increase cyber-threats in municipalities, businesses, and communities; and finally, an attack to information technologies infrastructure could disrupt most of the energy/water/food supply systems creating challenging circumstances for municipalities. Therefore, a higher reliance on ¹⁰ Economist. (2015) Retrieved from: http://economist.com/news/business/21700380-connected-homes-will-take-longer-materialise-expected-where-smart IT (especially in infrastructure) may put municipalities at risky situations if the IT systems fail. Also, it is important to mention that IT systems may entirely collapse due to wars or natural disasters affecting infrastructure in areas such as energy, water, health systems, food, transportation systems creating long-term and devastating effects for municipalities.

M7—Globalization and Economic Interdependence (FIG. 7¹¹: The global economic systems had never been as interconnected as they are nowadays. One clear example of this is how the financial crisis of 2009 impacted all global economies in the world. The links between stock exchanges have increased market efficiencies but also have increased the interdependency among different economies. A clear sign of this can be seen on FIG. 7 where the amount of global trade has increased dramatically in the last decades as never seen before in human history. And it seems that global trade may continue in this way for the next 20 years. Therefore, a model of total autarky looks less likely in the most important economies in the world, unless technological innovations are so embedded in the local economy that could decrease significantly the amount of good and services needed at a local level because of the production efficiencies created by the technology. But so far, in many countries most of airplanes, computers, cars, advanced machinery, or clothes are invented, designed, manufactured, and sold in different parts of the world, and it is not expected that within the next 20 years this trend could be dramatically different, unless another megatrend is strong enough to affect this megatrend in the following decades. ¹¹ Economist. (2015). Retrieved from: http://www.economist.com/blogs/graphicdetail/2015/10/global-trade-graphics

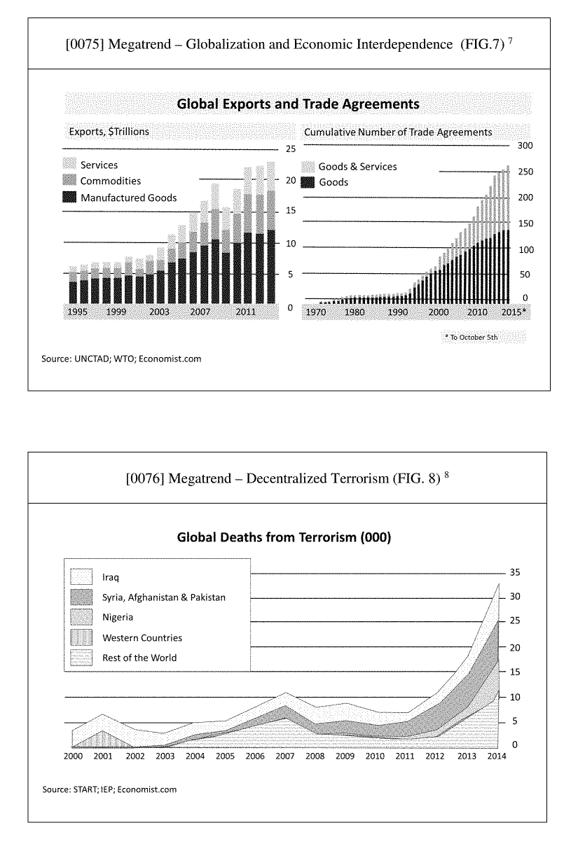

M8—Decentralized Terrorism (FIG. 8)¹²: Terrorism has increased significantly in the last decades. Globalization, population growth, and a higher urbanization rate have created riskier circumstances for municipal governments. Although most of the terrorist activities occur only in certain regions, it is important to consider that future wars, following a guerrilla/terrorist behavior, could take place more often in municipalities. In the future, municipalities will need to be better communicated and become more resilient to face terrorist attacks. For instance, an attack on local infrastructure may disrupt most of the important activities of the municipality. Municipalities that have decentralized, and interconnected supply chains of energy, water, and food could respond in a much better way to the terrorist attack. Resource efficiency is another aspect to consider. Efficient water and energy systems could minimize the impact of terrorist attacks on infrastructure. Decentralized terrorism, in-house terrorism, radicalism, and globalized terrorism could represent important challenges impacting the security planning process of cities and municipalities. Consequently, it is very convenient to understand that a small group of people could create a huge impact on municipalities. This small terrorist groups can paralyze municipalities and create profound economic impacts on public finances, and consequently, municipal governments should have the best security technologies and resilient strategies to overcome such challenges. ¹² Economist. (2015). Retrieved from: http://www.economist.com/blogs/graphicdetail/2015/11/daily-chart-12

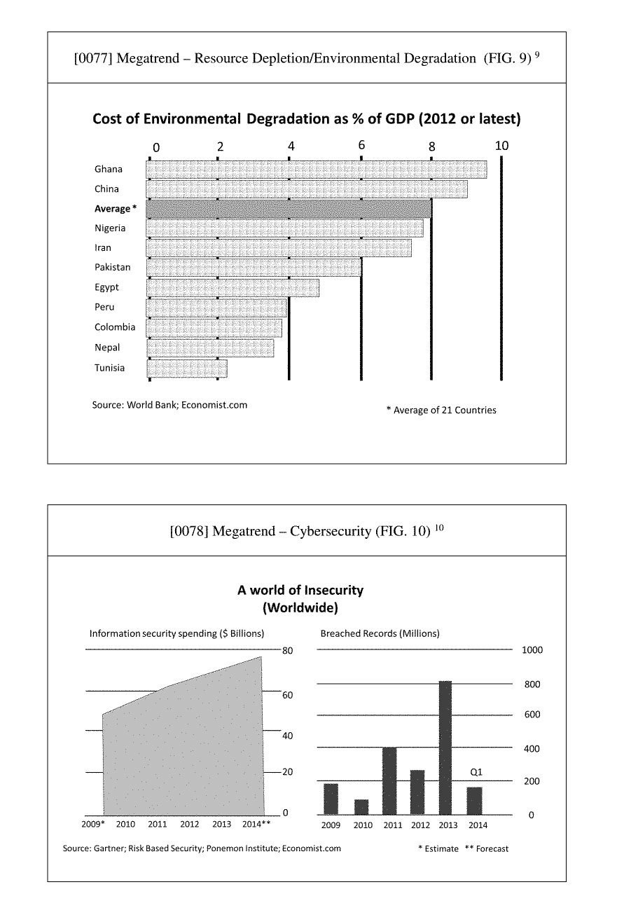

M9—Resource Depletion/Environmental Degradation (FIG. 9)¹³: The world does not have a problem of resources; it is more a problem of how resources are produced, managed, traded, and consumed. Resources such as water, energy, forests, and materials can be abundant in some regions but very scarce in some other regions. For instance, some municipalities may be vulnerable because of water scarcity, poor soil conditions, and scarce food, however, these regions may have abundant energy sources. These municipalities should know how many days of water and food have in case of a disaster impacting the municipality. On the other hand, other municipalities may have abundant water and food resources ¹³ Economist. (2012). Retrieved from: http://www.economist.com/node/17460954 but limited energy resources and should know how many days of energy would have in case of unforeseen events. However, if a trade agreement exists between both municipalities, the risks of environmental degradation could be minimized because water reservoirs would not be overexploited (in regions with less water resources) to produce food, because food would be produced where are more resources available to produce food (e.g. water). Also, if there were not trade agreements, then resources would not reach markets that do not have such resources. Consequently, some resources could be overexploited in places with limited resources. Additionally, population growth and a growing middle class in the global economy is putting under stress ecosystems and natural resources. Although technology plays an important role in decoupling prosperity with the consumption of natural resources, the consumption rate may still be higher in some regions than the rate of sustainable production. Or it could be the case that the production processes do not follow the best standards, creating scenarios of environmental degradation. Global central banks and the international monetary systems also play an important role on this issue. If more credit is created in the economy, more consumption would be created and a higher inflation could take place incentivizing commodity companies to extract more resources, unless new technologies or international agreements occur making more efficient the production of good and services in the coming decades. Finally, high availability of credit, used only for consumption and not for investment, could create long-term and unsustainable consumption habits. However, technologies making more efficient the production processes, higher urbanization rates, and smart city systems could decrease the correlation between resource use and economic development. Hence is where municipalities should understand the consumption/production equation of their critical resources.

M10—Cybersecurity (FIG. 10)¹⁴: The current digital age has forced citizens, governments, and organizations to deposit key information in digital systems which could be vulnerable to cyber-attacks. Cybersecurity issues have increased in the last years and at the same time, more citizens have become highly dependent on information technologies to carry out their daily activities. The more societies use information technologies, the more cybersecurity issues will occur. Therefore, cybersecurity risks in municipalities are an extremely important issue to consider when protecting the information and critical infrastructure that governments, organizations, and citizens use to carry out their daily activities. For instance, the number of cybersecurity issues has increased in the last years as can be appreciated in FIG. 10. Consequently, municipalities must be fully aware of this megatrend that may impact most municipalities during the 21^{st} century. ¹⁴ Economist. (2014). Retrieved from: http://www.economist.com/news/special-report/21606416-companies-markets-and-countries-are-increasingly-under-attack-cyber-criminals

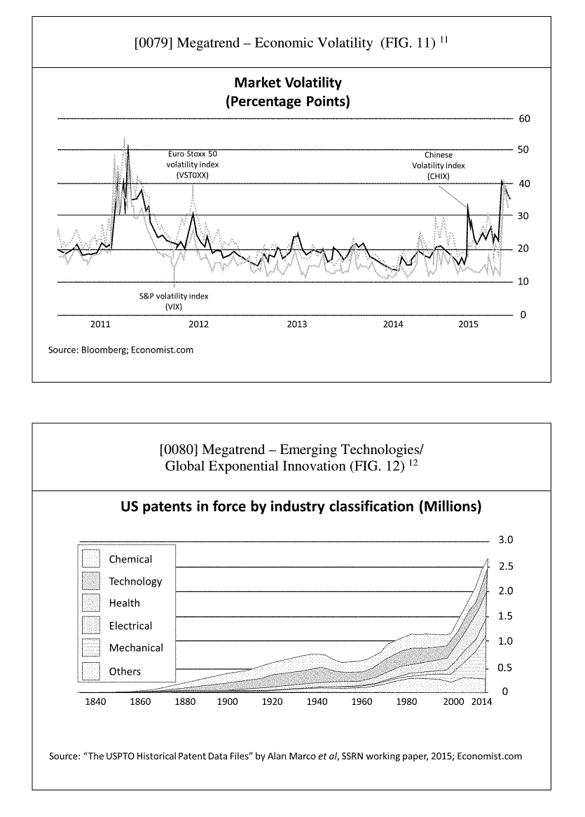

M11—Economic Volatility (FIG. 11) ^{15:} The global economic interconnectedness together with other megatrends could reduce the elasticity and resiliency capacity of global markets. The chaos effect, systemic risks, and the lack of effective global frameworks governing the world economy could have enormous implications to small and medium-size municipalities impacting their economies, creating a migration, and affecting their municipal infrastructure. The world economy had never been as interconnected as it is nowadays. On one side, globalization has created an interconnected system developing economic efficiencies, offering cheaper goods and services, and creating more innovation. But on the other side, this connection has also increased the likelihood of systemic risks where the chaos theory (or butterfly effect) could be a more common phenomenon. In the future, a higher level of interconnectivity could increase economic volatility where a higher demand for goods could generate higher volatility in the commodity markets which could impact the ¹⁵ Economist. (2016). Retrieved from: http://www.economist.com/news/economic-and-financial-indicators/21662566-market-volatility economies of municipalities. This can be appreciated with the volatility of energy prices impacting local economies and decreasing the predictability of government investments (as it happened during the oil peak prices in 2008). Finally, it is important to highlight that the world is currently more interconnected in terms of news and events, and the rapid flow of low-quality information, unconfirmed news (e.g. fake-news), or information without clear sources (to be traced back) can increase volatility in the markets.

M12—Exponential Global Innovation/Emerging Technologies (FIG. 12)¹⁶: The combination of population growth, Internet, higher education levels, and scientific competition derived from globalization, has created a high volume of innovations and patents around the world as it can be shown in FIG. 12. The innovation equation may be simple, more educated people, with higher access to high-quality scientific papers and knowledge, would accelerate the creation of innovations and technologies worldwide. But new scientific discoveries and emerging technologies may have advantages and disadvantages. For instance, one advantage is the impact that such technologies could have on the efficiency of the economy (e.g. information, transportation, communication, etc.). On the other hand, technologies such as engineered pandemics or a high reliance in automated/artificial intelligence systems, can also represent important risks to be aware of and leaders should understand potential scenarios if technologies are not used properly. Therefore, it is important for municipalities to understand such risks in order to develop municipal plans taking into consideration new inventions and innovations around the world. ¹⁶ Economist. (2014). Retrieved from: http://www.economist.com/node/21660559

### Municipal Challenges

The combination of the megatrends explained above together with short-term political thinking, inefficient/ineffective municipal strategies, and the inefficient coordination between some NGOs; may force city mayors, CEOs, and citizens to implement technology solutions, innovations, and strategies related to security, resilience, collaboration, sustainability, and economic competitiveness. Whether or not governments and citizens believe in climate change, megatrends such as population growth, global competition, new demographics, economic interdependence, cybersecurity threats, and an increased rate of natural disasters; are creating the need of more secure, sustainable, resilient, collaborative, intelligent, and self-sustained municipalities and organizations. Therefore, there is a clear opportunity to develop inventions, holistic methods, processes, technologies, and systems that globally connect municipal leaders and citizens with technology leaders, strategies, visions, innovators, and city developers by using digital technologies, innovative processes, thinking improvement technologies, and holistic development methods. These methods, systems, and processes could make possible the development of secure, sustainable, resilient, and economic municipalities around the world.

The Problem of Short-Term Thinking in Politics: Although it is not always the case, some political systems may tend to make their decisions following short-term thinking preoccupied with just winning the next election. Some governments and politicians may just want to win the election and make short-term thinking decisions to win the next election. Consequently, they don't invest in long-term strategies because these investments would not support them to win the next election. Other governments may follow short-term thinking because they do not have the resources to apply long-term strategies. Likewise, there are governments that make short-term investments in technologies that may work for a brief period of time, but that may not work after the government term ends, and the situation may create unsustainable future operational expenses, lack of accountability, and technology guarantee problems. Other governments may not have the vision or may not be even aware of how these megatrends might impact them, or decision-makers may not have the necessary knowledge or education to develop competitive, long-term, resilient, and sustainable municipal plans. Therefore, short-term thinking can create serious risks in some municipalities and the lack of proper information in the area of city planning and technologies could create scenarios where resources are not invested properly creating deficits or an inadequate use of resources. Therefore, it is necessary to make municipalities more aware of these megatrends, but also it is necessary to develop long-term and transparent models in the area of global city/municipal planning, city resilience, sustainability, and municipal security. Additionally, it is also needed to create a better connection between cities that may have the similar needs rather than just connecting cities because they belong solely to the same country or because municipalities belong to an international organization. New York, Shanghai, London, Paris, Nairobi, Abu Dhabi, Hong Kong, Tokyo, Mexico City, Sao Paulo may have similar challenges (demography, traffic, etc.) compared to the challenges faced in Austin, Freiburg, Curitiba, Boulder, Beppu, Mainz, or Oxford (which would be smaller communities with different transportation needs). And still, it is important to understand that there are differences between cities with similar complexity. Municipalities could have the similar demography, but different weather, demographics, governance culture, education, and development level. Finally, it is important to mention that the knowledge required for decision-making in municipalities in some cases may lack the necessary quality or may not be properly distributed well among all decision-makers. Each city may have different circumstances and needs, and therefore, solutions should be designed according to their specific municipal circumstances taking into consideration global standards and examples. Therefore, it is important to connect municipalities internationally that have similar needs, challenges, and long-term thinking.

Why Municipalities? National solutions created by national governments may still work in some situations and it is still important to have a level of centralization in governmental systems to deal with national issues. However, to tackle future megatrends challenges in the areas of security, sustainability, resilience, and economic competitiveness, it is needed a higher level of regionalization to customize solutions to specific needs. Here is the importance of not only connecting municipal leaders, but also the need to connect city managers, city advisors, city planners, politicians, and other stakeholders under a digital framework focused on key sectors, systems sizes, and taking into consideration the potential impact of megatrends described in the background section of this invention. Municipalities can be the central unit to develop and implement actions on a regional level. As of the year 2012, there were approximately 19,500 municipalities just in the USA according to the US Census Bureau ¹⁷. According to the UN (2015), there are more than 4,400 cities with more of 100,000 inhabitants in the world. But most of the municipalities in the world have less than 100,000 thousand inhabitants, and some of these municipalities might not have the budget to educate government staff as bigger municipalities can do. Therefore, a global digital framework is an excellent way to connect smaller municipalities with global solutions, without incurring in high costs and by taking into consideration municipality size, climatic conditions, geography among other factors to share innovations under a framework aligned to develop secure, resilient, sustainable, and economically competitive municipalities. ⁷ US Census Bureau. (2012)

A Cost-Effective Global Framework: A global framework creates a great opportunity to learn from other municipalities in the world with similar needs and conditions. Also, a global digital framework including key sectors could make possible to connect better solutions with specific needs and opens spaces for global collaboration and innovation. Currently, the world faces challenging megatrends where an efficient, agile, and effective global framework is necessary to face such complex global challenges. The methods, processes, key sectors, and systems integrated into a digital framework can create a technological tool for global governments to develop secure, sustainable, resilient, and economically competitive municipalities where staff would not need to travel long distances to learn about the best municipal development ideas. For instance, a digital framework using virtual reality, videos, and 3D systems has also the benefit of being periodically updated. In this way, city planning staff would not need to travel constantly to discover new ideas, solutions, or implementation results. Finally, the latest development of multimedia technologies, mobile/smartphone technology, new frameworks, systems, and methods allow the creation of cost-effective possibilities to municipalities and citizens around the world to learn about new innovations and development ideas without incurring in high traveling costs.

Inefficient Alternatives: Nowadays, there is not a global, digital, interactive, integrated with a systems thinking approach, and with a holistic framework efficiently providing specific solutions to key sectors and taking into consideration systems size, megatrends impacting the world, location, and key sectors focused on developing the sustainable, secure, resilient, collaborative, intelligent, and economically competitive municipalities. Additionally, most of the current alternatives that exist in several platforms may not be as interactive as needed and do not integrate virtual reality, 3D systems, smart-phone technology, videos, augmented reality, and artificial intelligence modules. Also, most of the current alternatives that provide information and solutions to municipalities are not holistic and are just focused on a couple of sectors leaving away other sectors that might be highly critical for the implementation of specific solutions. Most of the existing alternatives lack of a global approach, are just based on Internet databases, and do not follow a systemic and interdisciplinary approach (holistic approach) highly needed for municipal systems and for projects in the area of sustainable municipalities, economic competitiveness, community collaboration, resilient municipalities, and regional security. Finally, the information quality available on the Internet is not always segmented or organized properly, and videos describing certain strategies are not always found in a video database organized by sectors, municipal strategy, and systems size. Additionally, some of the global municipal leaders in the world (especially in remote areas) may lack good Internet access and it is difficult to receive updated information in the area of municipal development. Therefore, the lack of a global framework using the latest information and communication technologies (ICT) to connect inventors and technology leaders with city leaders and citizens, to educate decision makers, and connect local government officials may represent an important area for the coming decades to face future challenges and opportunities.

Reducing high volumes of disinformation: One of the main problems in regards the information utilized to develop municipal plans and projects, is the high volume of low-quality information (or misleading information) that can be found on the Internet. For instance, there are high volumes of videos in current search engines that do not have the necessary quality to be used in investment decision-making processes. Also, high-quality information can be unidentified when it is mixed with high volumes of low-quality information. However, by applying a modest fee to share the information, some digital platforms could increase the validity and authenticity of the information provided, especially when this information is shared in competitive systems to offer technological solutions to government. Additionally, some digital information can be falsified easily, but when an information source is linked to a financial transaction, then the chances to manipulate the information could decrease because information sources normally could be traced back to a registered entity in case of any malicious act. Another important point is to ensure that information is updated, complete, secure, and accurate. For instance, nowadays some search engines may show companies in a map as if these companies were still active, but in fact, some of these companies might not be active or in service anymore and this situation generates “junk” information in the system.

Finally, even though the information is openly available on the Internet, sometimes this information is not always organized properly following a systemic approach to solve specific problems. Or might be the case that the existing Internet algorithms (of the popular search engines) do not always provide the best technology suppliers in the local area, once the search performed by the users do not use a framework to define a specific objective or need. Also, some of the information provided by some companies providing solutions to municipalities may not always be updated because there is not a fee to force them to keep the information updated. Additionally, there might be the case that search engines don't apply the correct algorithm, or apply a generic algorithm to the user, or that such algorithms are limited to a country level search which would limit users to the possibility of finding better solutions offered in other parts of the world.

### Need/Problem

This background provides a solid base to support the need of the present invention which is based on a framework integrated by methods, systems, processes, and technologies with an objective to support government leaders and citizens in their processes to develop secure, sustainable, resilient, collaborative, and economically competitive municipalities. The present invention intends to improve the critical thinking and strategic knowledge of elected leaders and citizens following a systems thinking approach to make them aware of short and long-term challenges. The invention provides a global vision to global municipalities and its citizens to develop secure, sustainable, resilient, and economically competitive systems. Furthermore, it is important to acknowledge that the 12 megatrends mentioned in this document will have important impacts in our civilization during this century. Demographic growth, urbanization, climate change, natural disasters, epidemics, high reliance on IT/artificial intelligence, global economic interdependence, decentralized terrorism, environmental degradation/resource depletion, cybersecurity risks, economic volatility, and exponential global innovation/emerging technologies (e.g. Biotech, Artificial Intelligence, Nanotech) are dramatically impacting our civilization as never seen before in human history. These megatrends are creating higher stress in municipal systems, are creating high volumes of information, high volatility, more uncertainty, complex systemic risks, and new challenges in the area of decision-making processes used by government leaders and investors. In addition, inadequate decision-making, disinformation, inadequate city planning, and unexpected budget deficits due to natural disasters or economic volatility may create more economic crisis that could trigger regional conflicts, decrease global collaboration, create uncontrolled events (e.g. pandemics), decrease the rule of law, reduce good governance, and generate conditions for apocalyptic wars. Thus, it is important to understand the implications and how this context can create difficult challenges for municipalities and organizations in the area of security, sustainability, resilience, collaboration, and economic competitiveness.

On the other hand, our civilization has all the resources to face these challenges, however, the variable that missing to face the challenges properly, is related to the improvement of the kind of thinking of decision-makers in the municipality. With the existing technologies and with only a small percentage of the population, it could possible to produce the goods and services that the entire global population needs. Therefore, it is not a problem of availability of resources or technologies, or not even a problem of knowledge. The problem is the lack of a global framework to improve decision-making; it is the lack of scientific thinking in governmental decisions; and in some cases, is the kind of thinking of some elected leaders. Perhaps, the most difficult challenge is how to deal with human behavior or the kind of thinking. As previously mentioned, Albert Einstein highlighted that “We can't solve problems by using the same kind of thinking we used when we created them”. Therefore, our civilization may need a different kind of thinking during the 21^{st} century.

### Solution

The present methods, systems, processes, and technologies have four main objectives: (1) To provide world-class digital knowledge, education, media, visions, and solutions to elected city mayors/governors and citizens in order to improve their critical thinking, city visions, and behavior during the process of developing secure, sustainable, intelligent, collaborative, resilient, and economically competitive systems; (2) To make this knowledge thinking systems technically available to all municipalities in the world at a cost-effective manner; (3) To apply the latest technologies in the area of virtual reality for municipal planning, artificial intelligence, collective intelligence, augmented reality systems, digital advisory systems, and critical thinking improvement technologies to support global leaders, developers, and investors around the world; (4) and finally, to improve the kind of thinking following a top-bottom approach by applying the strategy of leading by example. People from the bottom would not improve their thinking processes if they see that their leaders are being successful by following inadequate practices.

The invention focuses on educating, connecting, and improving effectively the kind of thinking of leaders and citizens of more than 100,000 municipalities around the world by making them aware of current megatrends, key sectors, innovative ideas, successful societies, proven technologies, and strategies applied to have a successful municipality. The objective is to have a global, interactive, and multilingual digital framework using virtual reality tools, videos, human thinking improvement technologies, smart-phone technology, and artificial intelligence systems supporting municipalities, city planning staff, and intelligent cities with ideas and plans to develop secure, sustainable, resilient, collaborative, intelligent, and economically competitive governmental organizations. City mayors, governors, city staff, Congress, and smart citizens will have at their hands city cases, technologies, ideas, digital advisory systems, and strategies to design and plan their municipality, city, neighborhoods, or households by taking into consideration global trends and concepts related to security, sustainability, collaboration, resilience, and economic competitiveness.

Impact, Outcomes, and Beneficiaries: The methods, systems, processes and technologies included in the proposed framework intent to be global where leading technology leaders, NGOs, local distributors, developers, and advisors will have access to exchange knowledge around municipal solutions, ideas, concepts, and strategies with intelligent governments, private sector, and citizens. The direct beneficiaries will be the city mayors, governors, city planning offices, technology manufacturers, developers, and citizens who are truly willing to develop more secure, sustainable, economically competitive, collaborative, and resilient communities. It is expected that the solution may have a long-term cultural change where elected government officials will be more aware of the long-term effects of megatrends and of the potential solutions necessary to tackle future challenges.

Potential Alternatives: At this moment there is not a holistic global digital framework utilizing artificial intelligence, virtual reality, augmented reality, 3D systems, situational algorithms, collective intelligence, and videos taking into consideration megatrends and being organized by key systems, key sectors, and technology strategies supported by digital technologies specifically designed to cover the areas of security, sustainability, resilience, collaboration, and economic competitiveness. Advisory firms, city advisors, some governmental institutions, and NGOs sometimes provide a non-cost-effective service to municipalities. However, these entities normally don't share all the strategic information, may provide just theoretical support, and may be linked to a specific technology company or country with a potential existence of a conflict of interest. The proposed digital framework invention intents to be a global platform for any solution provider or government supplier willing to participate and to provide with ideas and solutions to municipalities and citizens. It also offers a cost-effective way to provide global municipal visions for key sectors and to explain the interactions, between sectors and megatrends, to smaller municipalities that may not have the resources to obtain high-quality knowledge related to this area. Besides, by using structured processes, holistic strategies, and visual methods, rather than just written methods, the platform intends to provide more realistic scenarios and ideas to leaders in order to improve their critical thinking at the time of developing sustainable, resilient, secure, and competitive municipalities.

Although some search engines platforms connect users with technology companies through databases, it is not done by following a well-defined framework including current megatrends, segmenting solutions according to complexity, and identifying key sectors affected by megatrends. The existing search engines normally provide information in high volumes and are not always organized by following a framework to connect users efficiently with adequate technologies and solutions to develop secure, resilient, sustainable, collaborative, and economically competitive cities/municipalities. Finally, it is important to mention that the high volumes of information coming from unpaid sources could make information less reliable and valid. Furthermore, information can be difficult to identify because high-quality knowledge could be unidentified in the vastness of information generated by the search engine algorithms which may not always prioritize information related to government suppliers (the search results bring mixed information from different sources). Therefore, it is expected that a paid-based system could improve the quality of information and authenticity of companies listed in the technology platform.

Theory Supporting the Thinking Process Improvement Technology: The use of virtual reality systems, augmented reality, videos, and written reports can provide better results at the time of transmitting knowledge to improve the thinking of elected leaders, to communicate city strategies, and to support leaders and citizens in their efforts to develop secure, sustainable, resilient, collaborative, and economically competitive municipalities. According to Cisco (2012), video technology can be extremely effective to educate decision-makers and to improve the thinking processes of people. For instance, in one report published by Cisco, it is mentioned that in the area of using videos for knowledge transfer and memory “the learner may remember and retain concepts better than with other instructional media” ¹⁸. This creates a perfect opportunity for municipal leaders and citizens who are willing to obtain high-quality knowledge to develop better municipalities. For instance, Ahn, S. et al (2013) highlight that “Immersive virtual environment technology (IVET) provides users with vivid sensory information that allow them to embody another person's perceptual experiences” ¹⁹. These technologies may provide excellent support to develop a vision in the area of city planning, to create empathy with less privileged communities, to develop architecture plans, to understand national security scenarios, to visualize ¹⁸ Cisco (2012). Retrieved from: http://www.cisco.com/c/dam/en_us/solutions/industries/docs/education/ciscovideowp.pdf¹⁹ Ahn, S. Minh Tran Le, A. & Baileson, J. (2013). The Effect of Embodied Experiences on Self-Other Merging, Attitude, and Helping Behavior. Media Psychology, 16:7-38, 2013 DOI: 10.1080/15213269.2012.755877 transportation systems, and to develop municipal plans. These technologies also provide the possibility to transmit knowledge and ideas to leaders who are located in remote areas, to leaders that cannot travel for various reasons, and also, have the advantage of updating the information continuously and the capacity to consult the information as many times as the users need it.

### BRIEF SUMMARY OF THE INVENTION

### Global Digital Framework to Improve Thinking and Decision Processes in Municipalities

The present invention consists of methods, systems, processes, and technologies integrating a global digital technology platform focused on developing secure, sustainable, resilient, collaborative, intelligent, and economically competitive municipalities, organizations, and communities. The technology framework takes into consideration, but is not limited to, twelve megatrends, twelve sectors, and seven technology modules to develop secure, sustainable, resilient, and economically competitive municipalities. The twelve sectors are divided in different systems depending on the size and complexity. The technology modules act as a catalyst to improve the thinking processes of elected leaders and to connect municipal governments and citizens with technology companies, NGOs, advisory firms, and city developers. The intended use of the present invention is to provide to city mayors, city advisors, NGOs, governors, citizens, investors, city planning professionals, industries, and communities with better digital tools to design cities, buildings, transportation systems, regional security strategies, and communities aligned with the best international practices in the area of energy, education, water, health, security, information technologies (IT), transportation, construction, food, environment, waste, and finance. The methods, systems, and processes included in this invention follow a systemic thinking approach and take into consideration the location, profiles, interactions of sectors, and the specific needs of users by utilizing algorithms, collective intelligence systems, and technology strategies that would function as a personalized intelligent advisor guiding technology users to innovations and technologies. The invention works as a new communication system using, but not limited to, videos, virtual reality tools, augmented reality systems, interactive forums, virtual markets, artificial/collective intelligence systems, thinking process improvement technologies, and global strategic knowledge to assist organizations in developing intelligent, sustainable, collaborative, secure, and resilient municipalities in the 21″ century. One of the objectives is to communicate knowledge to improve the thinking processes of elected leaders and citizens to develop of secure, economically competitive, sustainable, and resilient organizations in the 21st century by providing the correct solution to the specific municipal needs.

### BRIEF DESCRIPTION OF THE SEVERAL VIEWS OF THE DRAWING (IF ANY)

Not Applicable

### DETAILED DESCRIPTION OF THE INVENTION

### Conceptual Model

Before the present invention is described with more details, it is necessary to explain that this invention (methods, processes, and systems) is not limited to the areas described previously, since the application of the invention may vary depending on the type of organization and the number of methods, processes, and systems integrating the framework. Finally, the framework is not intended to be limited to the organizations, modules, or technologies described, since the methods, processes, and systems could utilize alternative technologies and modules to carry out the specific objectives of the invention.

### Invention

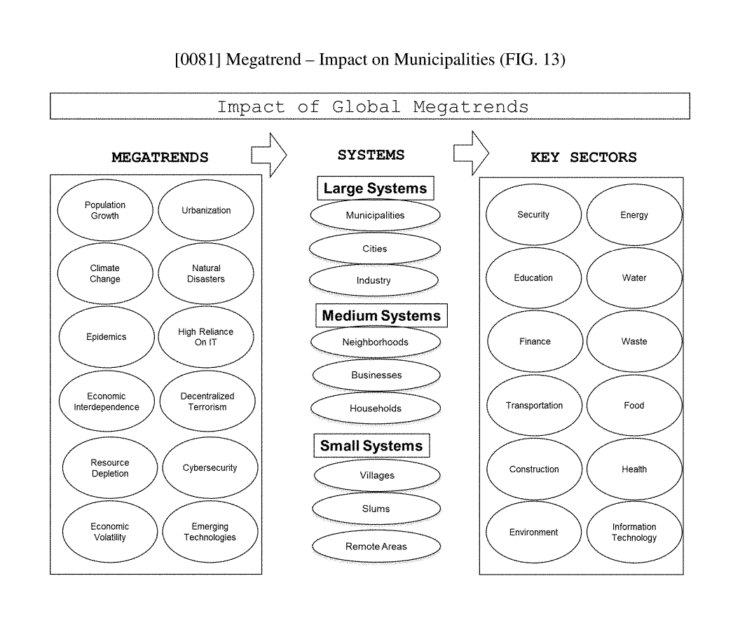

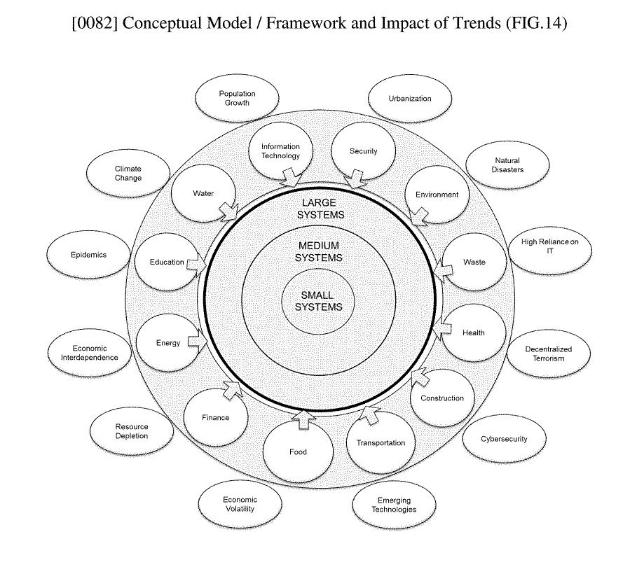

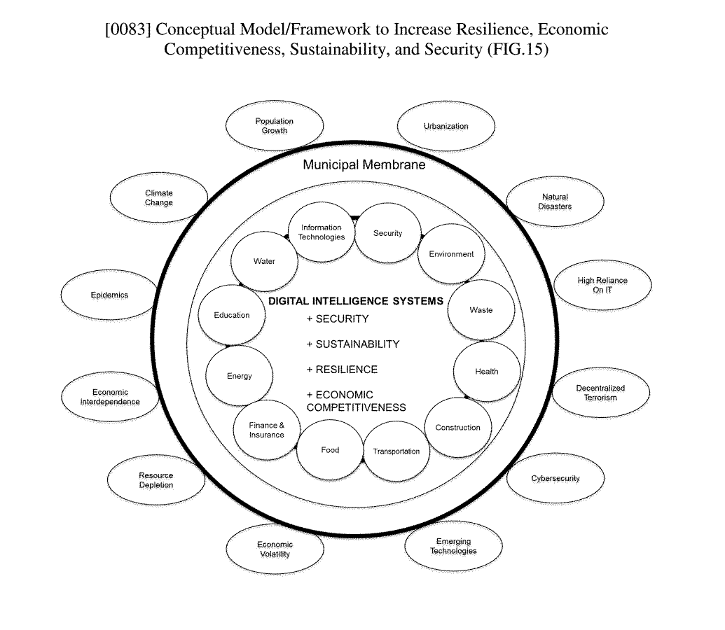

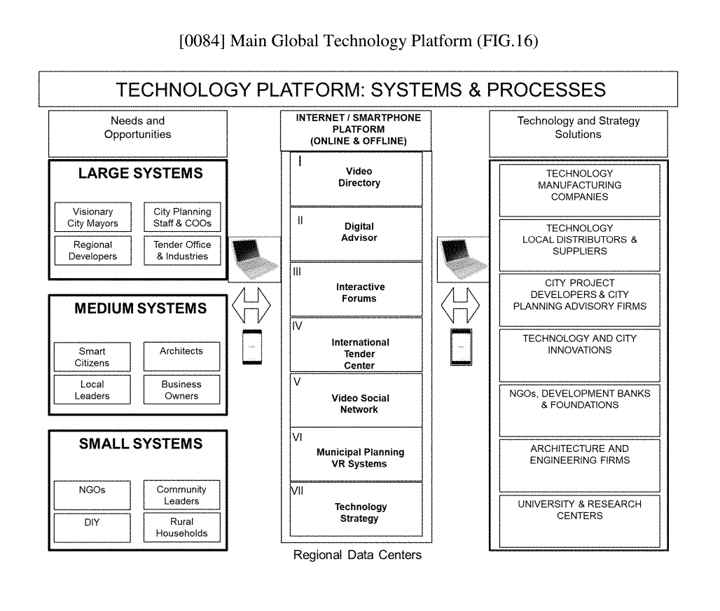

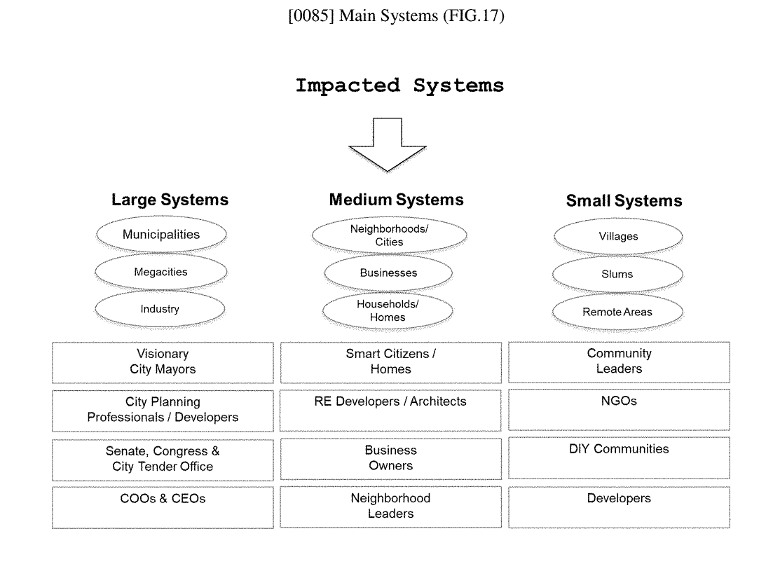

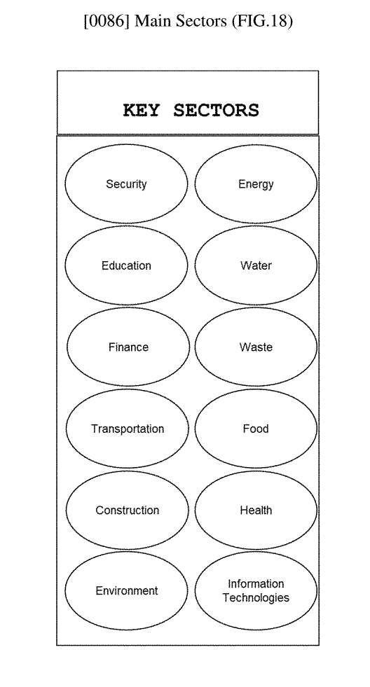

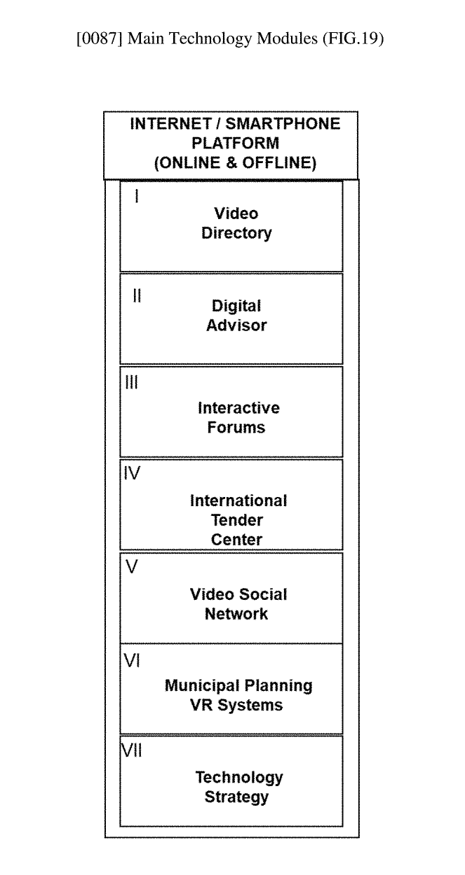

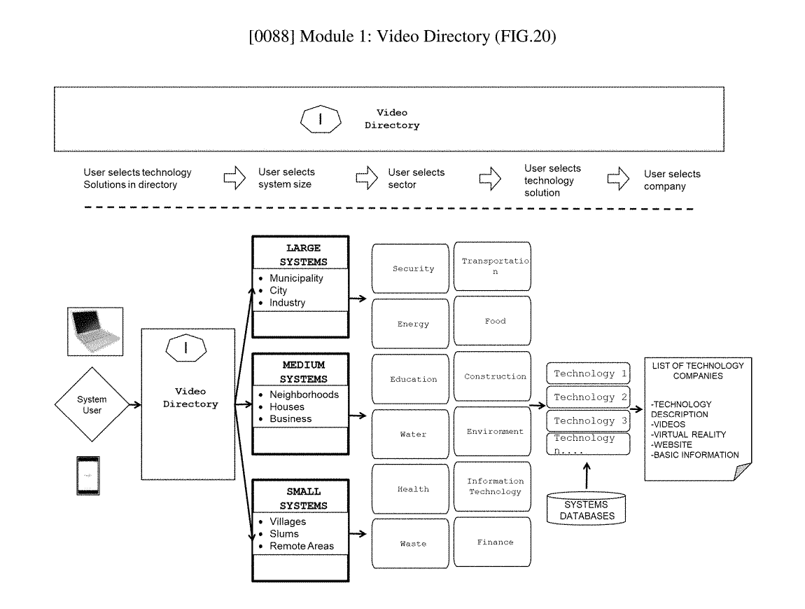

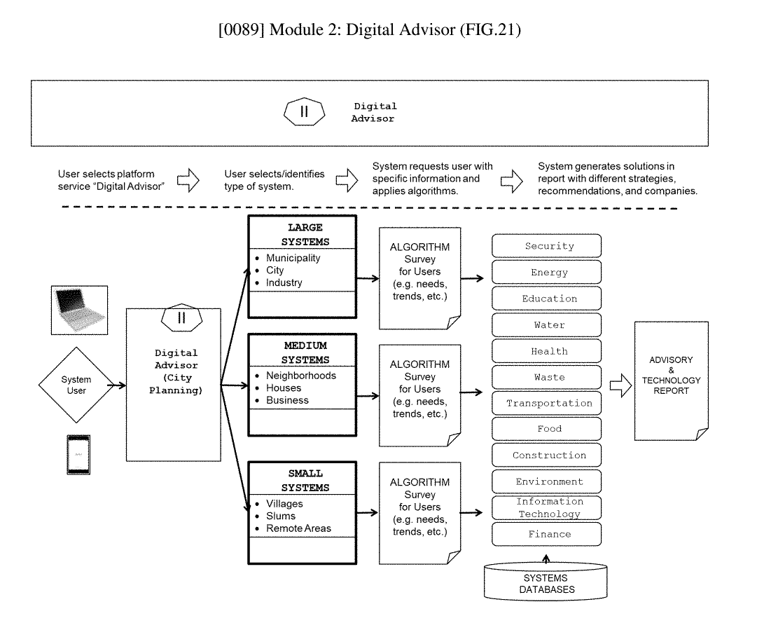

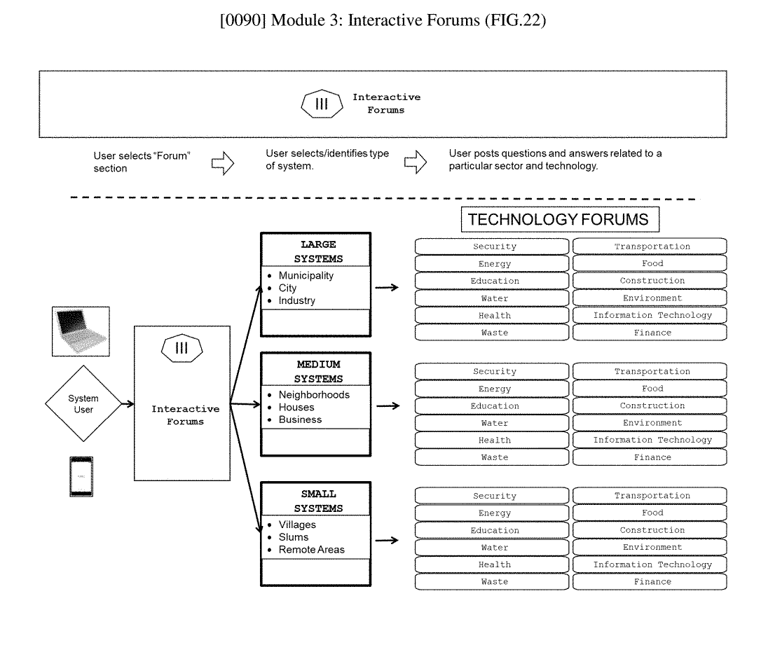

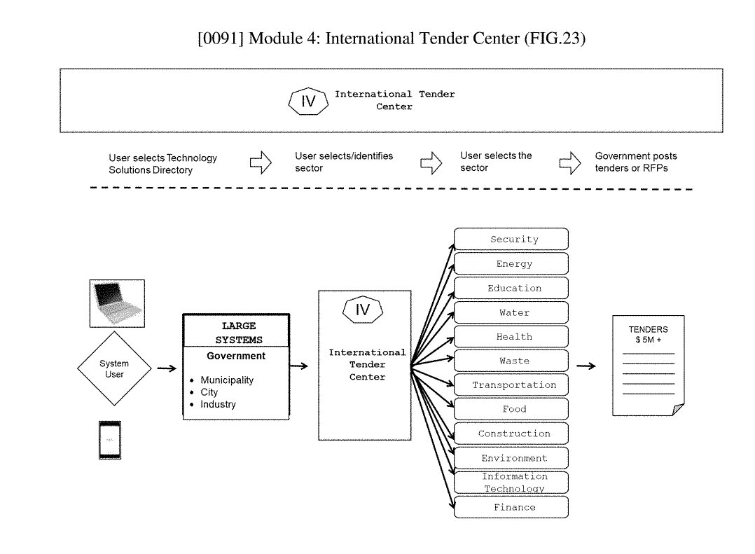

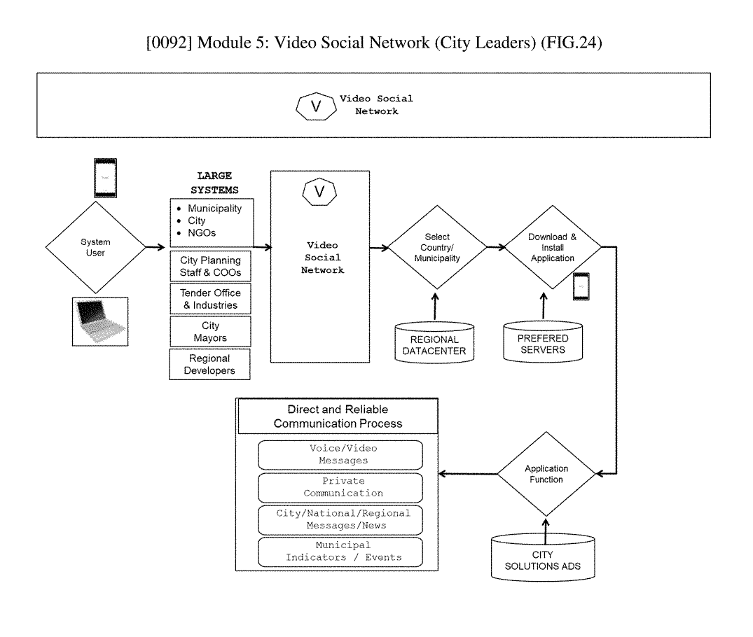

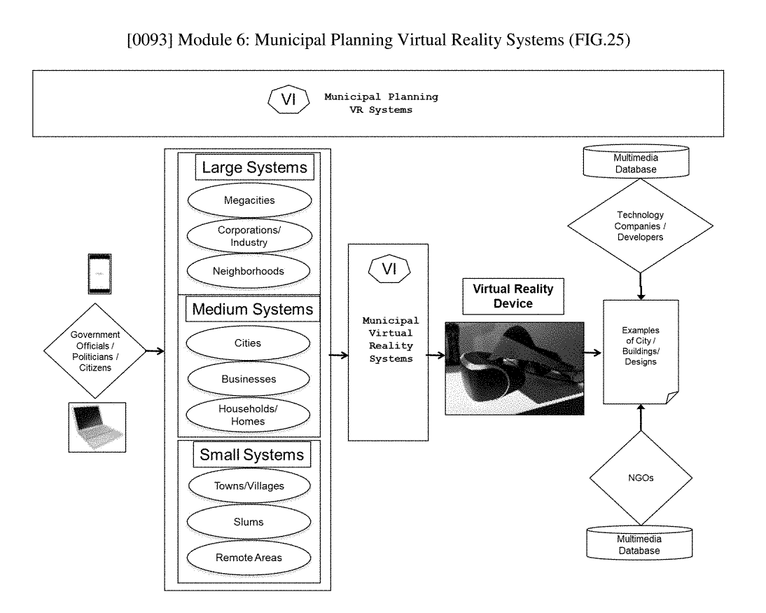

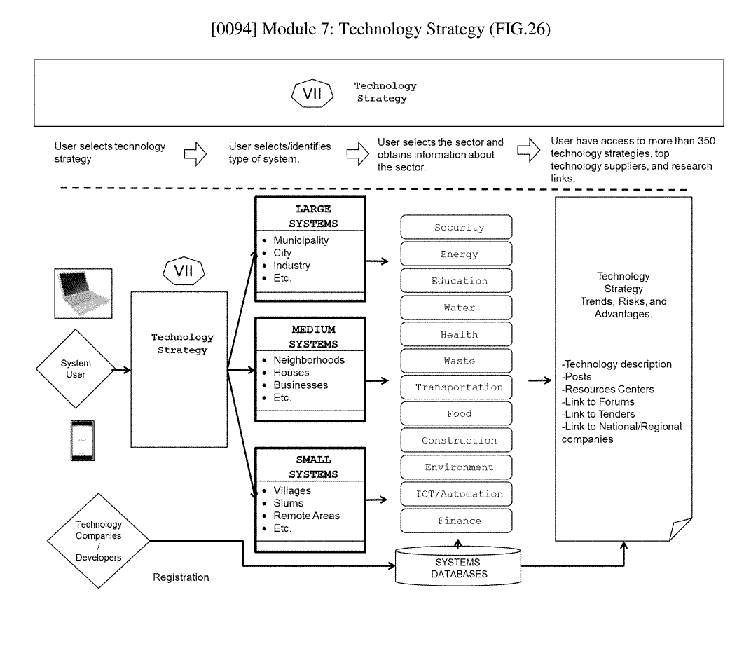

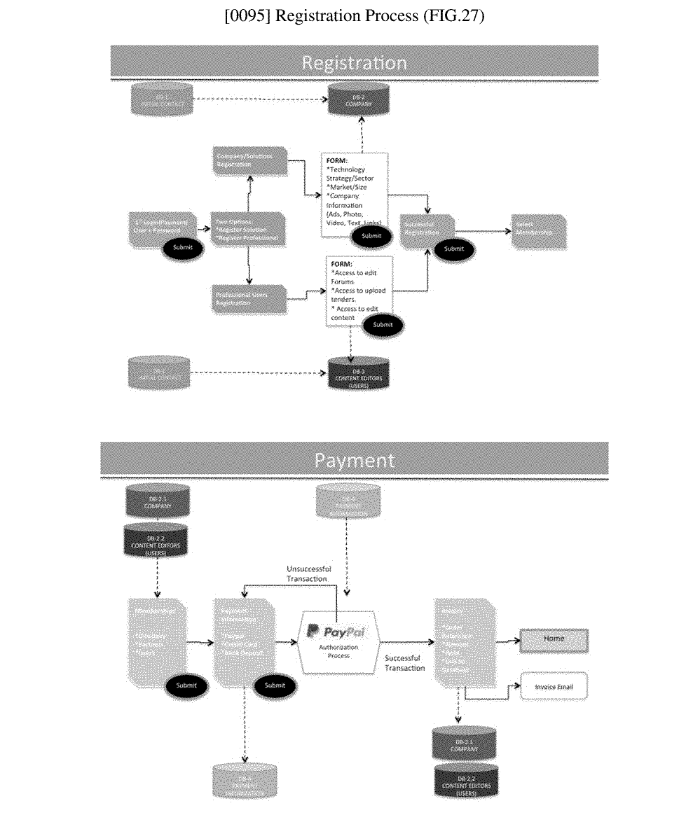

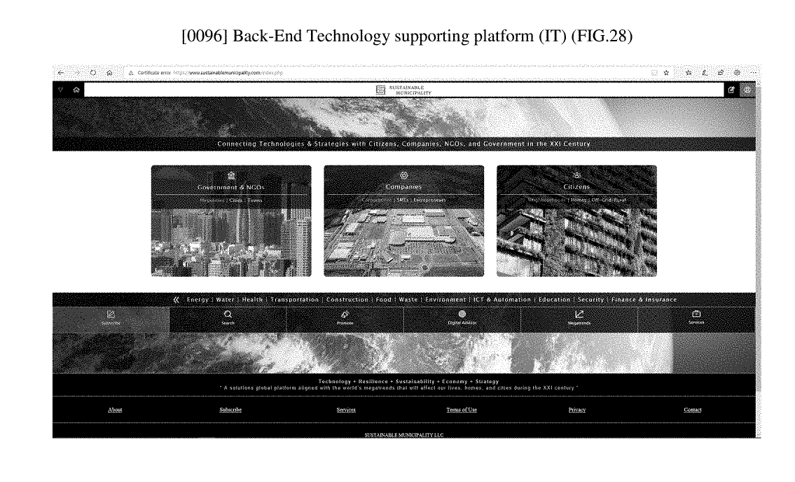

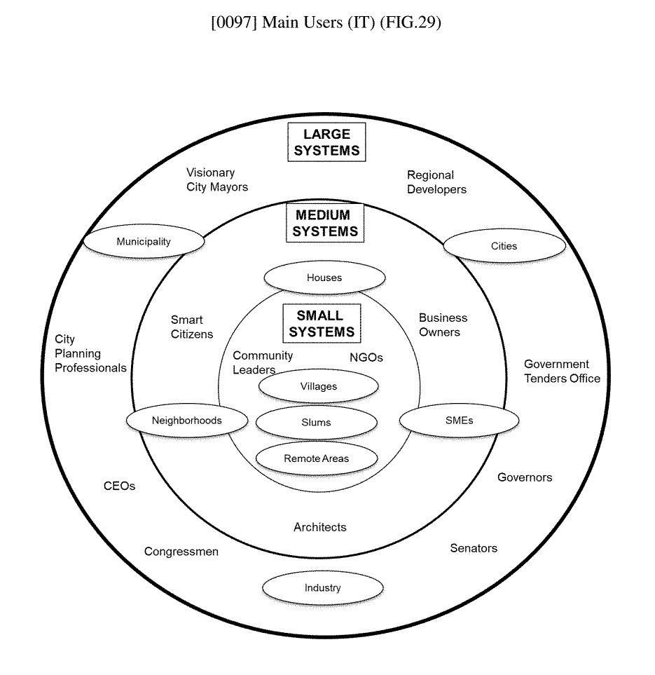

The present invention consists of methods, systems, technologies, and processes that integrate a global digital technology platform to develop secure, sustainable, resilient, collaborative, intelligent, and economically competitive municipalities, industries, organizations, and communities. The design of the invention takes into consideration twelve current megatrends that impact three systems (FIG.13). The methods, systems, and processes take into consideration the interaction of megatrends, systems, and sectors as shown in the main conceptual model (FIG. 14). The global digital framework integrates processes, methods, systems, and technologies that can work together or independently to improve the security, sustainability, collaboration, resilience, and economic competitiveness of organizations and municipalities (FIG. 15). The global framework is applied through a digital platform (FIG. 16) containing systems, methods, and technologies segmented in three systems depending on the size and complexity of users (FIG. 17) in such manner that the platform can facilitate the application and understanding of solutions depending on the structure of governmental systems, municipal systems, community systems, and economic systems. The technology platform covers twelve sectors (FIG. 18) and provides, but is not limited to, seven innovation modules (FIG. 19). The seven technology modules (FIG. 20-FIG. 26) cover the twelve key sectors for municipalities, cities, organizations, and communities (large, medium, and small systems). The technology framework utilizes the seven technology modules as a catalyst to connect municipal governments and citizens with technology leaders, NGOs, and city developers; and to improve the thinking processes of elected leaders and citizens. These modules are: Video Directory (FIG. 20); Digital Advisor (FIG. 21); Interactive Forums (FIG. 22); International Tender/Procurement Center (FIG. 23); Video Social Network (City Leaders/NGOs) (FIG. 24); Municipal Planning Virtual Reality Systems (FIG. 25); and the Technology Strategy Module (FIG. 26). The intended use of the present invention is to facilitate and optimize the process of providing virtual reality systems, digital information, concise knowledge, multimedia social networks, and a virtual space to communicate advanced knowledge to different users around the world (FIG. 29). The users of this platform can be city mayors, governors, city planning advisors, NGOs, citizens, investors, city planning professionals, industries, developers, and communities or any entity looking to develop competitive, secure, sustainable, intelligent, healthy, and resilient organizational systems (e.g. municipalities). The methods, systems, processes of the framework follow a systems thinking approach and take into consideration the location, profiles, holistic interactions, and the specific needs of users who may be supported by hardware such as smart-phones, tablets, virtual reality systems, augmented reality systems, artificial intelligence systems, and regionalized computer infrastructure (FIG. 28). The framework also offers an efficient and effective design to add content, to register solutions, to process payments, and to perform interactive knowledge exchange activities (FIG. 27).

### Main Objectives

The current invention has a global and multilingual approach (based on visual technologies) that collects, processes, and disseminates knowledge around the world to improve economic systems in four areas: Security, sustainability, resilience, and economic competitiveness. The framework contains methods, systems, technologies, and processes that allow decision makers and investors to be aware of current trends, innovations, technologies, concepts, and strategies to develop agile and successful municipalities. The main objectives of the invention are: (1) To provide knowledge, education, and solutions to citizens and elected government officials in order to improve their critical thinking, municipal visions, and behavior during the process of developing secure, sustainable, resilient, collaborative, and economically competitive organizations; (2) To make knowledge available to all municipalities in the world in a cost-effective manner by providing an efficient, effective, and innovative interactive space to solutions providers (e.g. technology suppliers), advisors, and decision makers to develop more secure, sustainable, resilient, and economically competitive organizations; (3) To apply the latest technologies in the area of virtual reality for municipal planning, artificial/collective intelligence systems, augmented reality systems, digital advisory, and critical thinking improvement technologies to support global leaders, developers, and investors around the world in their investment decision-making processes; (4) To allow leaders from smaller communities and cities to have access to world-class knowledge, systems, and development ideas in key sectors to develop intelligent communities without the need of travelling to remote locations; (5) To leverage on emerging technologies (3D systems, virtual reality, ethical algorithms, artificial intelligence, behavioral technologies, etc.) to provide real successful experiences and innovative visions to city mayors, governments, and citizens around the world; (6) To efficiently and effectively connect global technology manufacturers, distributors, inventors, and developers with city mayors, city planning staff, tenders offices, smart citizens, community leaders, and remote villages; (7) To increase the quality of information provided on the Internet (and android applications for off-line systems) by uploading solutions from valid entities or from citizens/companies that already have proved the solution, and by applying a token fee; (8) To decrease the amount of “junk” information or “fake-news” available on the internet that could be used by some municipal leaders to make investment decisions; (9) To increase the availability of high quality information by avoiding algorithms that provide just regional solutions or ideas that do not include the best international practices. The platform is designed to provide freedom to the users allowing them to perform searches at any location; (10) And finally, to improve the thinking processes of elected leaders and citizens including, but not limited to, a top-bottom approach where the strategy of leading by example is applied in the society.

### Main Components (Methods, Systems, Technologies & Processes)

The proposed framework has been divided strategically in three systems: (a) Large Systems including, but not limited to, megacities, industrial systems, large scale technologies, utility systems, neighborhoods, and large scale industries; (b) Medium Systems including, but not limited to, households, off-grid systems, small businesses, homes, commercial buildings, NGOs, medium size cities, and big buildings; and finally, (b) Small Systems including, but not limited to, technology solutions and ideas for remote communities, slums, towns, off-grid-systems, rural areas, and small villages. The framework also defines twelve strategic key sectors (FIG. 18) that are impacted by twelve megatrends mentioned in the background section of this document. The framework is used to create a digital technology tool integrated, but not limited to, by seven modules that are used to have an interactive and efficient digital space to improve leader's thinking processes and to develop strategies for municipalities, cities, communities, and organizations.

### Main Systems

The digital framework and conceptual model take into consideration the interactions between sectors and megatrends following a systems thinking approach to develop a holistic understanding of the organizational system (e.g. municipalities). Also, the framework is divided in three systems depending on the user, complexity, size, and technology strategy. This approach provides a more efficient interaction and less complex process to provide information to users where search inputs are selected by the users and not by algorithms that may be biased. Additionally, although some search engines platforms can connect governments with technology companies through algorithms, it is not done by following a well-defined framework covering the current megatrends, by segmenting solutions depending on complexity, and by identifying key sectors (FIG. 18) affected by megatrends. This design provides freedom to the users to select what they want to search for and to avoid the influence preloaded algorithms. At the same time, information is better organized and is only focused on the development of secure, sustainable, collaborative, resilient, and economically competitive municipalities. For instance, the existing search engines normally provide information in high volumes and information is not always organized by following a framework to efficiently connect users with the correct technologies to develop secure, collaborative, resilient, sustainable, and economically competitive cities. Finally, the high volumes of information coming from unpaid sources could make information less reliable and valid. Or high-quality information can be difficult to identify because it gets lost with a vastness of information generated by the search engine algorithms, which might be biased with previous searching activities. The digital framework divides users in three large systems: Large systems, medium systems, and small systems but is flexible enough to divide systems into sub-systems depending on the development of future solutions.

Large Systems: The large systems section is created for complex municipal systems, utilities, industries, megacities, and complex organizations where city mayors, municipal planning officers, city managers, CEOs, COOS, government procurement offices, and industrial parks can find an interactive framework to identify global ideas, strategies, networks, and technologies to develop intelligent organizations capable of facing future challenges and opportunities from coming megatrends.

Medium Systems: The medium system section can include homeowners, small-businesses, off-grid systems, and commercial systems for medium-size cities where smart citizens, neighborhoods, and small business owners among others can find solutions to develop smart buildings, secure communities, healthy living, and cost-effective resilient systems for their communities. Some of the innovations may be transportation technologies, health technologies, water systems, off-grid systems, and Do-It-Yourself (DIY) technologies focused on resource efficiency, healthy living, smart residential management systems, and sustainable architecture among other solutions.

Small Systems: The small systems section is designed to provide an interactive space where community leaders, NGOs, development banks, villages, towns, entrepreneurs, and citizens can find affordable technologies and ideas to develop better communities, off-grid systems, disaster recovery plans, and rural communities focusing on finding simple innovations and ideas to improve their health, education, food/energy/water security, resilience, security, and sustainability.

### Technology Modules

The methods, systems, and processes integrating the global digital framework include seven technology modules creating an interactive learning space for municipalities and citizens and a connection place to link technology companies with final users. The seven modules target different user needs and are designed to have a global approach covering the twelve sectors mentioned above. All modules have a scoring functionality (e.g. favorites database) used by the users/members to categorize, save, and prioritize the quality of information provided in the platform. The following paragraphs describe the seven modules:

Module 1: Video Directory (FIG. 20): The Video Directory module leads to users to technology strategies and innovations for each one of the key sectors. This module allows technology manufacturers, technology distributors, local suppliers, and developers to upload video ads showing technologies, solution cases, documentaries, and application of technologies. This module allows governments and citizens to identify, understand, and visualize the application of such technologies and ideas around the world. The video directory shows and prioritizes relevant videos depending on their interest, location, and selections while using the digital framework.

Module 2: Digital Advisor (FIG. 21): The digital advisor module provides a series of questions and unbiased algorithms to platform users (smart-phone/pc interfaces) supporting them in the identification and design of solutions to develop secure, resilient, sustainable, and economically competitive societies. This module takes into consideration megatrends, critical national security questions, scenario analysis, local resources, demographics, consumption habits, and other development frameworks related to technology companies, advisory firms, financiers, and development banks that support municipalities in the design of city planning strategies. This module creates an interactive platform providing knowledge to municipal leaders by using artificial/collective intelligence systems, design software, and virtual reality systems providing a cost-effective method for small municipalities in the world to obtain and share high-quality knowledge in order to make better investment decisions. The module has different algorithms depending on the systems size and physical location of the user, but users are always free to change input variables. The algorithms are designed to avoid biases and users are free to input the variables required by the algorithm to provide the best result (input variables are not preloaded in the algorithms and previous searching activities do not affect future searching results).

Module 3: Interactive Forums (FIG. 22): The interactive forum module provides a space to platform users to ask and answer questions regarding to the specific technology and city innovation strategy that users are looking for. It also provides a space for technology leaders to become more aware of the market needs for each technology strategy and to discuss the advantages and disadvantages of technology. Users will need to pay a modest membership to become part of the forum in such way that the risk of using fictitious accounts (e.g. bots) and posting irrelevant, or misleading information, could be minimized. The objective is that a modest fee can have a positive effect on the quality of the information that is being exchanged by avoiding accounts that are not linked to a reliable source.

Module 4: International Tender Center (FIG. 23): The International Tender Center is a module where governments can publish tenders (using an independent communication channel) or get support related to the design of tenders around the municipal infrastructure focused on developing secure, sustainable, resilient, and economically competitive municipalities. International tenders in the area of high-speed trains infrastructure, municipal security, education technologies, cultural change technologies, municipal waste systems, ICT solutions, public health, water systems, food security, energy security, sustainable transportation, etc. could be published in this module to create a more competition among companies and more transparency, and consequently, better services and lower costs related public infrastructure. The objective is to create a space (an international and not just a regional B2G) for government tenders offices and companies where they can prioritize investments to develop more secure, sustainable, resilient, and economically competitive municipalities and communities.

Module 5: Video Social Network (City Leaders) (FIG. 24): The video social network module provides a mobile platform for city mayors, city managers, and governors around the world. This module can be regionalized by country where city leaders could have contact with other government leaders by sending short videos to ensure the authenticity of the message. The invention prioritizes on visual technologies, since current social media accounts sending text messages can be hacked, and other people could impersonate city mayors delivering fictitious messages (visual technologies may reduce the risk of this point). Therefore, the use of short videos could make hacking activities more difficult to achieve. With the video social network system, government leaders can communicate straight messages to the citizens without using intermediaries at the time of delivering urgent and important messages to the community. The application and platform are based on an open-source software national or international network to increase the coordination among city mayors in case of emergencies (e.g. pandemics). The video social network application system also has the possibility of creating surveys among members and of posting announcements (e.g. emergency alerts).

Module 6: Municipal Planning Virtual Reality Systems (FIG. 25): This module provides an interface for city mayors, governors, government officials, city planners, city advisors, and NGOs leaders to visualize global cities, infrastructure projects, and successful municipalities by using virtual reality, videos, and augmented reality systems. This virtual reality tool is a cost-effective technology to support any municipal leader in the world in the process of developing city visions, technologies, architecture plans, and infrastructure plans without traveling to the place where the technology was implemented. This module also provides an efficient way for city mayors of smaller municipalities to have access to technologies and ideas that could support them in the creation of sustainable, resilient, secure, and economically competitive communities. Finally, the virtual reality systems also intend to work as a technology to improve the thinking processes of elected municipal leaders and citizens in areas related to security, resilience, collaboration, sustainability, and behavioral finance.

Module 7: Technology Strategy (FIG. 26): This module lists more than 350 technology strategies in the sectors of education, security, energy, water, health, ICT, automation, transportation, construction, food, environment, waste, finance, and insurance. This module provides knowledge and news about technology strategies including the advantages and disadvantages of the technology. On the other hand, users can learn about the technology and its applications to develop secure, sustainable, resilient, and economically competitive municipalities. Additionally, this module provides with global manufacturers, technology suppliers, local distributors, and developers prioritizing solutions by scores provided by clients, by content level, or by physical location taking into consideration altitude and latitude coordinates.

### Technology Support

The methods, systems, and processes of the digital framework are supported, but not limited to, by front-end technologies such as HTML, XML, JavaScript, JQuery, Ajax, or Python. The back-end technologies supporting the algorithms are also supported, but not limited to, by technologies such as MYSQL, Oracle Database, Linux, Unix, C++, C+, C, C #, Go, Python, Java, PHP, Virtual Reality Software, among others. The global technology framework may include mobile technologies using iOS, Android, C, C+, C++, Java, and Python programming languages among other smart-phone programming languages that allow easy access to content in remote areas without the need of conventional computers or Internet connection. The digital framework also contemplates the use of satellite communications, regional telecommunication systems, and other hardware necessary to carry out activities in the area of virtual reality, Internet, software, GPS technology, sensors technology, artificial intelligence, video technology, augmented reality, behavioral change technologies, sound technology, and other systems to develop secure, resilient, sustainable, and economically competitive municipalities, organizations, households, and communities.

1. A global digital framework to improve the thinking processes and knowledge of elected leaders and citizens specifically designed to cover 12 key sectors in municipalities such as education, security, energy, water, health, information technologies (IT), transportation, construction, food, environment, waste, and finance in order to holistically develop secure, resilient, sustainable, collaborative, and economically competitive economies.

2. A global technology platform segmented by organizational systems depending on entity size and complexity, and depending on the solutions included in the framework in such way that the time used during the knowledge transfer can be optimized and effectively learned.

3. An interactive global framework containing methods and processes providing strategic technological solutions, innovations, and concepts to municipalities, cities, and communities following a systems thinking approach and utilizing technologies in the area of smart-phone technology, multimedia databases, virtual reality systems, augmented reality systems, artificial intelligence systems, Systems, advanced sensors, behavioral change technologies, social network systems, and video technologies.

4. A global technology platform where technology manufacturers, technology designers, city developers, technology suppliers, NGOs, Institutes, advisory firms, architects, municipal developers, national security services, governmental technology, and regional technology suppliers/developers can demonstrate their solutions to cities/municipalities by taking into consideration location, specific needs of users, and current megatrends affecting the sustainability, resilience, security, and economic competitiveness of municipalities.

5. A global digital framework designed to face challenges and opportunities derived from the current interaction of megatrends such as: (M1) global demographic growth, (M2) urbanization, (M3) climate change, (M4) natural disasters (e.g. earthquakes, tsunamis, etc.), (M5) Pandemics/Epidemics, (M6) high reliance on IT/artificial intelligence systems, (M7) global economic interdependence, (M8) decentralized terrorism, (M9) resource depletion/environmental degradation, (M10) cybersecurity, (M11) economic volatility, and (M12) and global exponential innovation/emerging technologies.

6. A global and systems thinking digital framework to develop secure, sustainable, collaborative, intelligent, resilient, and competitive municipalities which takes into consideration the impact and interactions of global demographic growth, urbanization, climate change, natural disasters, epidemics, high reliance on IT/artificial intelligence, global economic interdependence, decentralized terrorism, environmental degradation/resource depletion, cybersecurity risks, economic volatility, and exponential global innovation/emerging technologies (e.g. Biotechnology, Artificial Intelligence, Nanotechnology, etc.); to the key sectors of energy, education, water, health, security, information technologies (IT), transportation, construction, food, environment, waste, and finance.

7: A global digital framework including, but not limited to, seven technology modules which combination creates a robust platform and a cost-effective method that can be used virtually by remote governments at any part of the world in order to improve the thinking processes of elected leaders, and which also can be used to visualize and to learn about technologies, development concepts, governance systems, and simple innovations aligned to achieve optimal results in the area of municipal sustainability, resilience, collaboration, security, and economic competitiveness.

8. Module 1—A global video technology directory platform providing video ads showing technologies and innovations specifically filtered by municipalities, cities, and households in the world and divided in 12 strategic sectors which are segmented in systems depending on the specific user needs and allowing governments and citizens to understand and to visualize the application of such technologies and ideas by prioritizing relevant videos depending on the users interest, physical location, and specific needs with the objective of creating sustainable, resilient, secure, and economically competitive municipalities/cities/organizations.

9. Module 2—A global digital advisory system in the area of sustainability, resilience, security, and economic competitiveness designed with algorithms and artificial intelligence systems supporting users in the identification of strategies and plans to be aware of risks and opportunities in their communities in order to develop secure, resilient, sustainable, and economically competitive societies. The digital advisory system takes into consideration megatrends, critical national security questions, scenario analysis, and development frameworks linked to technology companies, financiers, and development banks that could support municipalities in their design of municipal strategies. It also provides a cost effective method for small municipalities in the world to obtain and to share high quality knowledge in order to make better investment decisions. The technology advisory system has different algorithms depending on the complexity and location of the user.

10. Module 3—An interactive forum module providing an space to platform users to ask and answer questions in regards the specific technology and city innovation strategy that they are looking for. It also provides the space to technology leaders to be more aware of the market needs for each technology strategy and to discuss the technology advantages and disadvantages. The forum provides a virtual reality interface to participate in virtual forums with governmental leaders and member who might be interested in the topic. Users may need to pay a modest fee for a membership to become part of the forum in order to minimize the risk of using fictitious accounts posting irrelevant or misleading information.

11. Module 4—A global tender platform where municipal governments can list international tenders in the area of high-speed trains, municipal security, education technologies, sustainable energy infrastructure, municipal water systems, municipal waste systems, public, health, IT solutions, etc. covering the sectors of education, security, energy, water, health, information technologies (IT), transportation, construction, food, environment, waste, and finance in order to create secure, sustainable, resilient, and economically competitive municipalities and communities.

12. Module 5—A video social network providing a mobile platform to city mayors, city managers, and governors around the world and organized by country. The video social network allows users to establish contact to other city leaders through short videos in such way that they can ensure the authenticity of the message. The solution avoids sending text messages that can be hacked by other people impersonating city mayors and delivering fictitious messages. The use of this tool integrated in the framework would make hacking activities more difficult by using video technology. The video social network systems allows government leaders to communicate direct messages to the citizens without using intermediaries at the time of delivering urgent and important messages to the community. The application and platform is based on open-source software to increase the coordination among city mayors in the nation in case of emergencies or important notices (e.g. pandemics). The video social network application system also has the possibility of creating surveys among member and has also the capability of posting important announcements from governments.

13. Module 6—A virtual reality module integrated in a holistic global platform providing an interface to city mayors, governors, global government officials, city planners, city advisors, smart citizens, and NGOs to visualize global cities, infrastructure projects, and successful municipalities through the use of virtual reality, videos, and augmented reality systems. It also provides an efficient way to elected city mayors of smaller municipalities to have access to technologies and ideas that could support them in the creation of sustainable, resilient, secure, and economically competitive communities. The virtual reality systems work as a technology system to improve the thinking processes of municipal leaders and citizens in areas related to governance, sustainability, resilience, and behavioral finance.

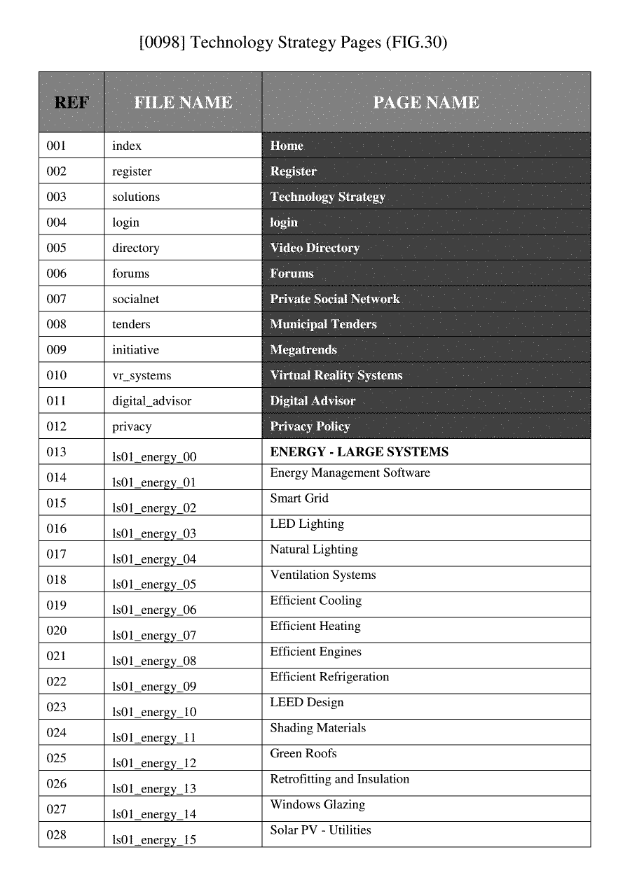

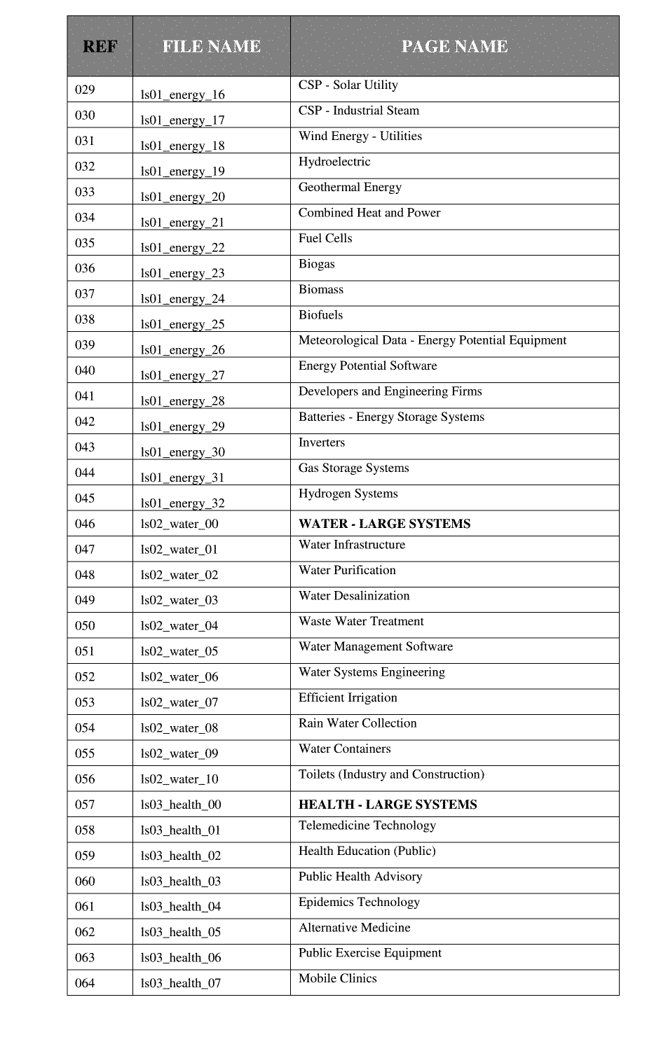

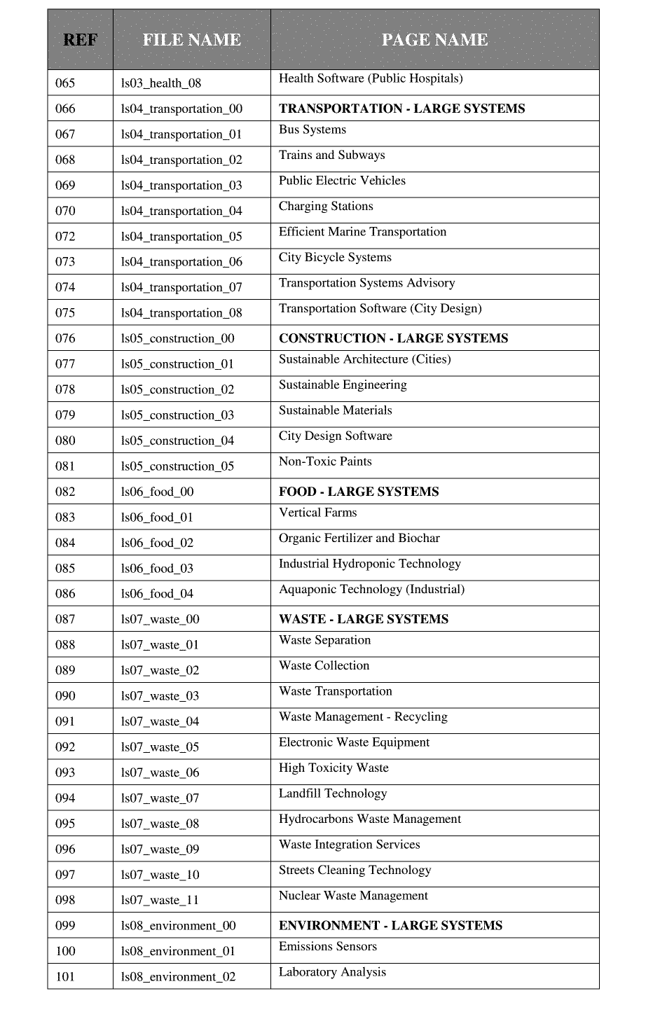

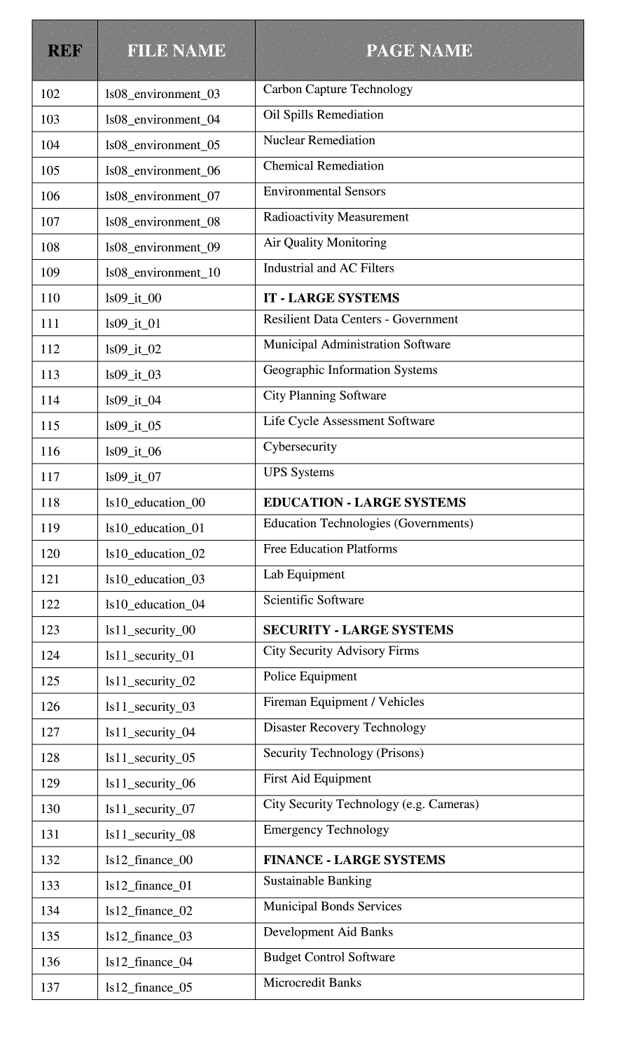

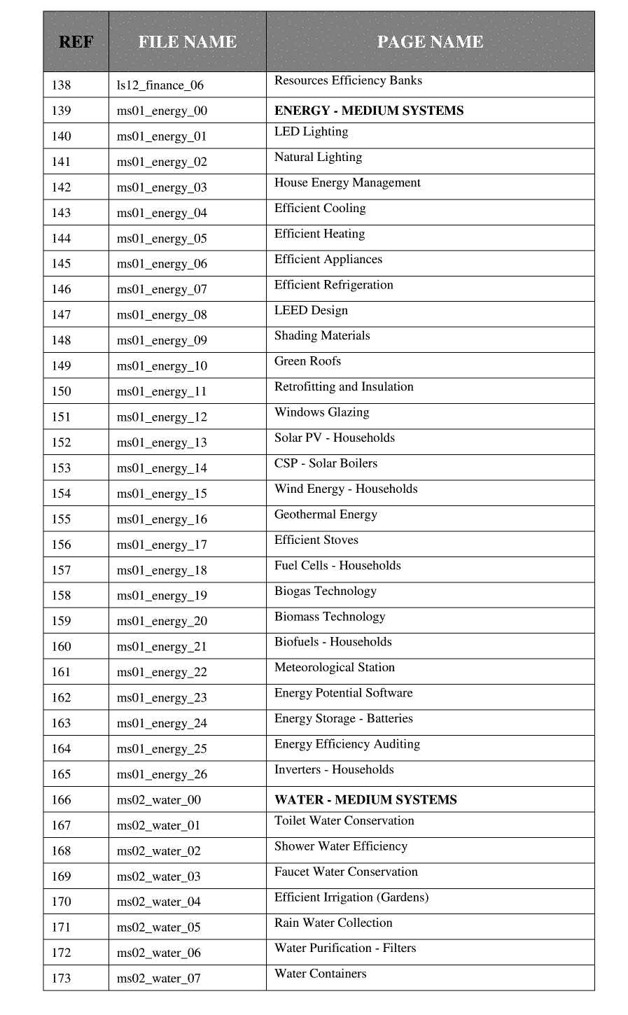

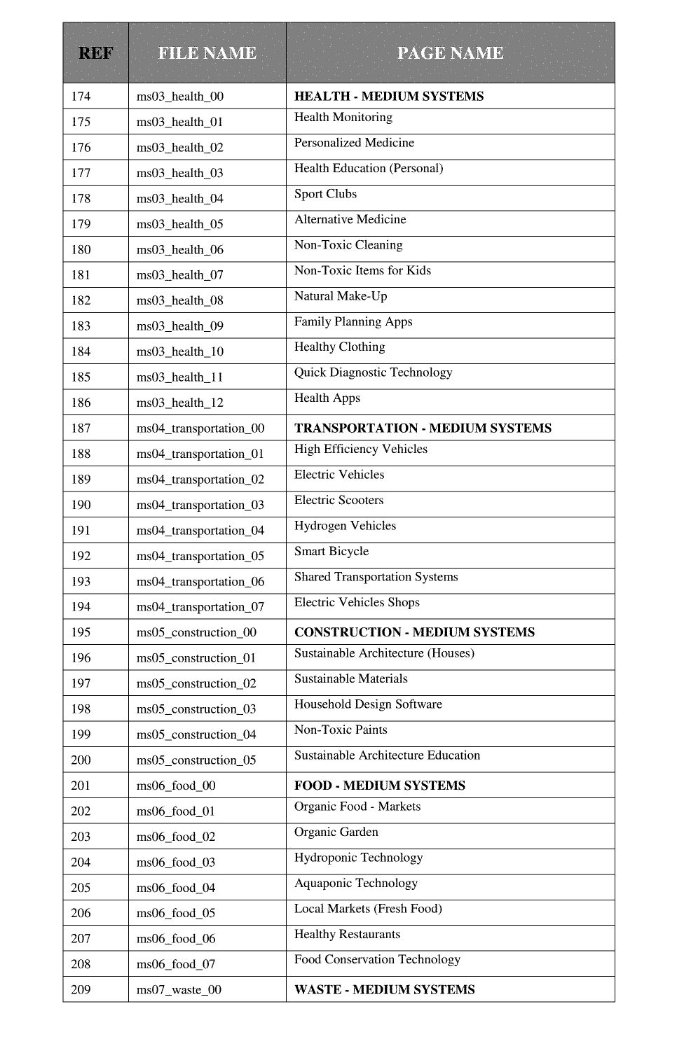

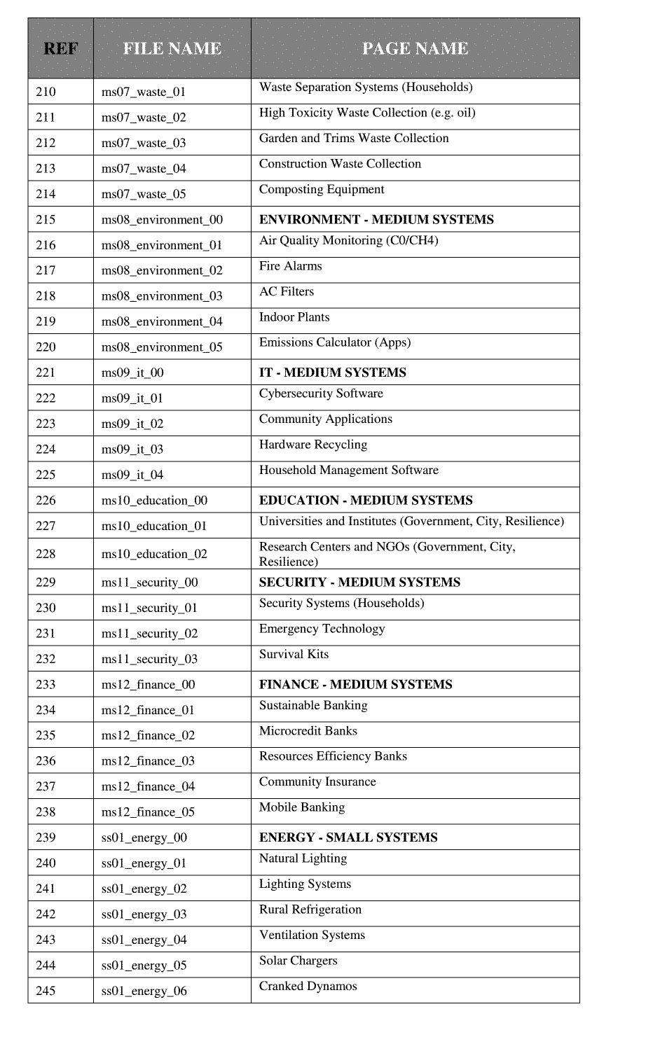

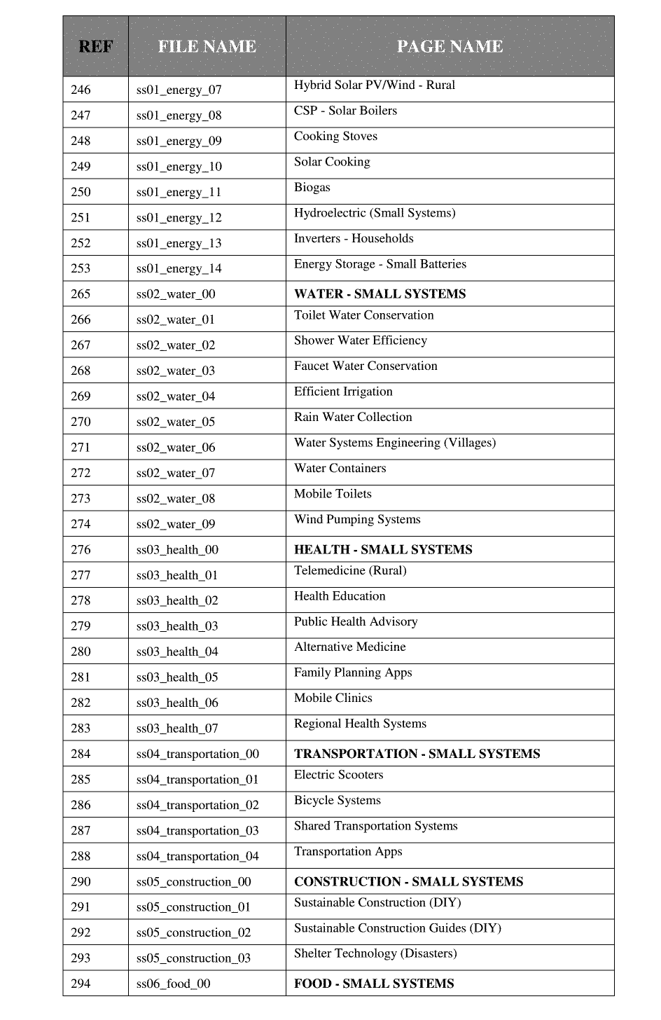

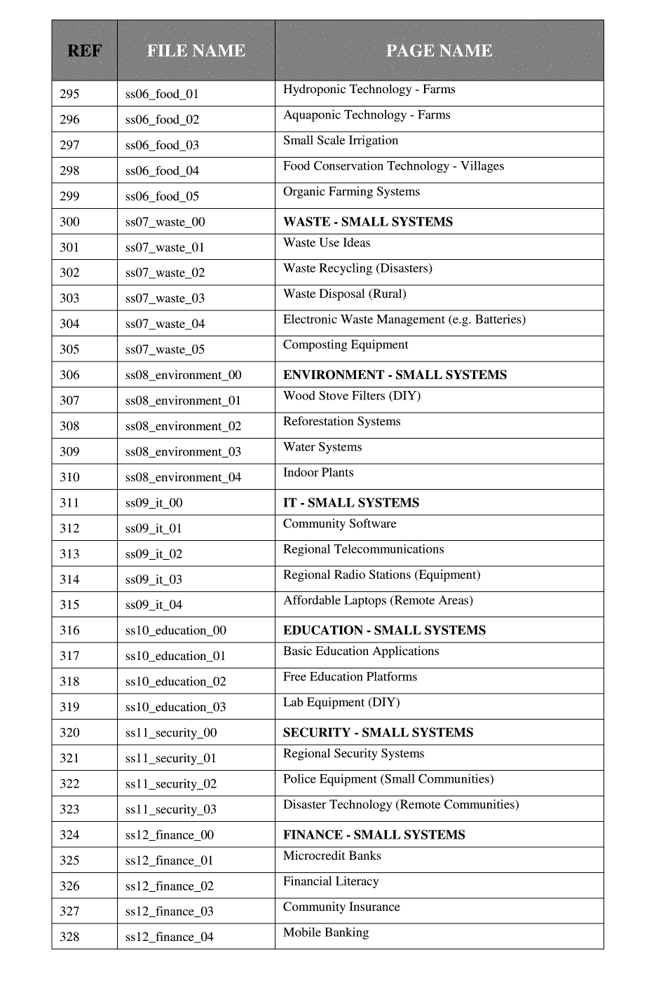

14. Module 7—A digital technology platform providing descriptions, news, and reports of more than 350 technology strategies (FIG. 30) in the sectors of education, security, energy, water, health, information technologies (IT), transportation, construction, food, environment, waste, and finance. The technology module provides knowledge and news about technology strategies, advantages, and disadvantages using a process which is focused on secure, sustainable, resilient, and economically competitive municipalities leading users to top companies in their region, and without limiting the availability of new technologies and ideas being used in other parts of the world. This technology module provides top potential distributors, technology suppliers, local distributors, and developers depending on, but not limited to, the physical location taking into consideration altitude and latitude coordinates. The module decreases the amount of “junk” information available to users by filtering information under the systems and sectors and by forcing content providers to execute a economic transaction to ensure the validity of the information.

15. A paid-based economic model to increase the quality and volume of high quality knowledge and technologies provided by technology companies, advisory firms, and city developers made available to governments during their investment decision-making process to develop secure, sustainable, resilient, collaborative, and economically competitive organizations.

16. A communication technology platform that does not favor any political group, is free of conflict of interest, and which only intention is to present best cases, technologies, and proven ideas to all municipalities around the world. Therefore, it is a framework that avoids the behavior of some political groups, NGOs, and institutions, which sometimes may be presenting ideas being influenced by internal groups or donors.

17. A content technology platform where content providers need to make a payment in order to ensure the quality of the information that is uploaded and to verify the authenticity of the users and content providers by linking their user accounts to a valid online bank account in such way that attacks of robots and viruses having negative effects on the platform information quality could be decreased.

18. A technology platform listing most foundations and institutes around the world organized by the sectors of education, security, energy, water, health, information technologies (IT), transportation, construction, food, environment, waste, and finance. The technology platform aligns the efforts of global foundations towards the development of secure, resilient, sustainable, and economically competitive cities by connecting foundations and NGOs, and by supporting them to tackle challenges derived from megatrends mentioned in the background section.
